(19) United States
(12) Patent Application Publication
(10) Pub. No.: US 2018/0316403 A1
(43) Pub. Date: Nov. 1, 2018

(54) BASE STATION SYSTEM AND COMMUNICATION CONTROL METHOD

(71) Applicant: FUJITSU LIMITED, Kawasaki-shi (JP)

(72) Inventors: Masafumi TSUTSUI, Kawasaki (JP); Hiroyuki Seki, Kawasaki (JP)

(73) Assignee: FUJITSU LIMITED, Kawasaki-shi (JP)

(21) Appl. No.: 16/028,025

(22) Filed: Jul. 5, 2018

Related U.S. Application Data
(63) Continuation of application No. PCT/JP2016/051658, filed on Jan. 21, 2016.

(51) Int. Cl. H04B 7/06; H04B 7/0456; H04L 5/00; H04W 16/28

(52) U.S. Cl. CPC H04B 7/0617; H04W 16/28; H04L 5/0053; H04B 7/0456

(57) ABSTRACT

A base station system includes: a plurality of antenna units each of which includes an antenna and is configured to be coupled to the plurality of antenna units via a communication channel; and a control circuit configured to be connected to at least one of the plurality of antenna units via a communication line, the control circuit being configured to perform radio communication using any of the plurality of antenna units via the connected antenna unit.

### CROSS-REFERENCE TO RELATED APPLICATION

This application is a continuation application of International Application PCT/JP2016/051658 filed on Jan. 21, 2016 and designated the U.S., the entire contents of which are incorporated herein by reference.

### FIELD

The embodiment discussed herein is related to a base station system and a communication control method.

### BACKGROUND

In the related art, mobile communication systems are known such as a 3rd generation (3G) mobile communication system, an LTE mobile communication system that corresponds to a 3.9th generation mobile communication system, an LTE-Advanced mobile communication system that corresponds to a 4th generation mobile communication system, and a 5th generation (5G) mobile communication system. LTE is an acronym for Long Term Evolution. Furthermore, there is known a configuration that connects a plurality of antennas in a base station in a mobile communication system.

Examples of the related art include International Publication Pamphlet No. WO2012/026318, Japanese Laid-open Patent Publication No. 2013-31168, and Japanese National Publication of International Patent Application No. 2014-514848.

### SUMMARY

According to an aspect of the invention, a base station system includes: a plurality of antenna units each of which includes an antenna and is configured to be coupled to the plurality of antenna units via a communication channel; and a control circuit configured to be connected to at least one of the plurality of antenna units via a communication line, the control circuit being configured to perform radio communication using any of the plurality of antenna units via the connected antenna unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a base station apparatus according to an embodiment;

FIG. 2 is a diagram illustrating another example of the base station apparatus according to the embodiment;

FIG. 3 is a diagram illustrating an example of a routing table for an antenna unit (#11) according to the embodiment;

FIG. 4 is a diagram illustrating an example of a routing table for an antenna unit (#10) according to the embodiment;

FIG. 5 is a diagram illustrating an example of a routing table for an antenna unit (#12) according to the embodiment;

FIG. 6 is a diagram illustrating an example of a routing table for an antenna unit (#13) according to the embodiment;

FIG. 7 is a diagram illustrating an example of a configuration relating to a downlink signal of a router according to the embodiment;

FIG. 8 is a diagram illustrating an example of a configuration relating to an uplink signal of the router according to the embodiment;

FIG. 9 is a diagram illustrating an example of a configuration relating to a downlink signal of a BB unit according to the embodiment;

FIG. 10 is a diagram illustrating an example of a configuration relating to an uplink signal of the BB unit according to the embodiment;

FIG. 11 is a diagram illustrating an example of a transmission channel, for which a single unit and a single antenna in the base station apparatus according to the embodiment are used;

FIG. 12 is a diagram illustrating an example of a transmission channel, for which a single unit and a plurality of antennas in the base station apparatus according to the embodiment are used;

FIG. 13 is a diagram illustrating an example of a transmission channel, for which a plurality of units and a single antenna in the base station apparatus according to the embodiment are used;

FIG. 14 is a diagram illustrating an example of a transmission channel, for which a plurality of units and a plurality of antennas in the base station apparatus according to the embodiment are used;

FIG. 15 is a diagram illustrating an example of a reception channel that is used for a single unit and a single antenna in the base station apparatus according to the embodiment;

FIG. 16 is a diagram illustrating an example of a reception channel, for which a single unit and a plurality of antennas in the base station apparatus according to the embodiment are used;

FIG. 17 is a diagram illustrating an example of a reception channel, for which a plurality of units and a single antenna in the base station apparatus according to the embodiment are used;

FIG. 18 is a diagram illustrating an example of a reception channel, for which a plurality of units and a plurality of antennas in the base station apparatus according to the embodiment are used;

FIG. 19 is a flowchart illustrating an example of processing relating to the downlink signal that is received through the antenna unit according to the embodiment;

FIG. 20 is a flowchart illustrating an example of processing relating to the uplink signal that is received through the antenna unit according to the embodiment;

FIG. 21 is a diagram (the first one of the two diagrams) illustrating an example of a transmitted signal in a case where the base station apparatus according to the embodiment uses a single unit and a single antenna;

FIG. 22 is a diagram (the second one of the two diagrams) illustrating an example of the transmitted signal in a case where the base station apparatus according to the embodiment uses a single unit and a single antenna;

FIG. 23 is a diagram (the first one of the two diagrams) illustrating an example of the transmitted signal in a case where the base station apparatus according to the embodiment uses a single unit and a plurality of antennas;

FIG. 24 is a diagram (the second one of the two diagrams) illustrating the example of the transmitted signal in the case where the base station apparatus according to the embodiment uses a single unit and a plurality of antennas;

FIG. 25 is a diagram illustrating an example of the transmitted signal in a case where the base station apparatus according to the embodiment uses a plurality of units and a single antenna;

FIG. 26 is a diagram illustrating an example of the transmitted signal in a case where the base station apparatus according to the embodiment uses a plurality of units and a plurality of antennas;

FIG. 27 is a diagram illustrating an example of a received signal in a case where the base station apparatus according to the embodiment uses a single unit;

FIG. 28 is a diagram illustrating an example of the received signal in a case where the base station apparatus according to the embodiment uses a plurality of units; and

FIG. 29 is a diagram illustrating another example of coupling between the antenna unit and a control station according to the embodiment.

### DESCRIPTION OF EMBODIMENT

In the related art, as described above, in some cases, it is difficult to realize an antenna configuration that has a high degree of freedom. For example, in the case of configuring a base station apparatus that includes many antennas, it is considered that a plurality of antenna units are combined, but in some cases, wiring between each of the plurality of antenna units and a control station becomes complicated in the related art.

According to an aspect of the present disclosure, provided are technologies regarding a base station apparatus to realize the antenna configuration that has a high degree of freedom.

A base station apparatus and a communication control method according to the embodiment will be in detail below with reference to the drawings.

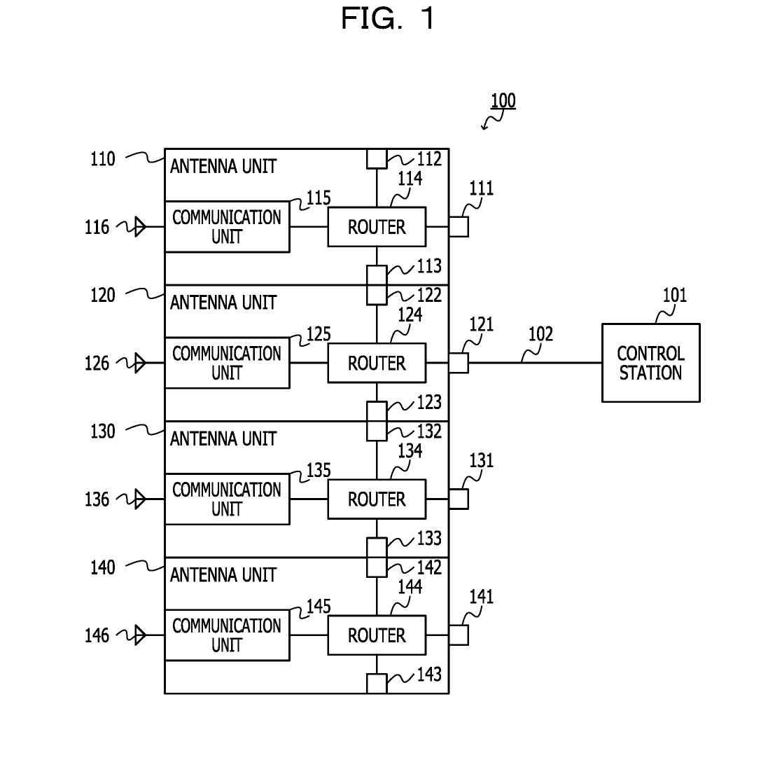

FIG. 1 is a diagram illustrating an example of the base station apparatus (also referred to a base station system) according to the embodiment. As illustrated in FIG. 1, a base station apparatus 100 according to the embodiment includes a control station 101 (also referred to a control circuit), and a plurality of antenna units, antenna units 110, 120, 130, and 140. For example, the base station apparatus 100 is a base station that is capable of performing radio communication between the base station apparatus 100 and a mobile station. The control station 101 is a communication control apparatus that controls the radio communication which uses the antenna units 110, 120, 130, and 140. The antenna units 110, 120, 130, and 140 are units that each have one or more antennas and are possibly connected to each other.

Under the control of the control station 101, the base station apparatus 100 performs Multiple Input Multiple Output (MIMO) that uses an antenna of each of the antenna units 110, 120, 130, and 140. For example, the base station apparatus 100 performs precoding (beamforming), space division multiplexing, diversity coating, or the like that uses MIMO. A case will be described below where the base station apparatus 100 performs the precoding that uses MIMO.

The antenna unit 110 includes an inter-control station I/F 111, inter-unit I/Fs 112 and 113, a router 114, a communication unit 115, and an antenna 116. The inter-control station I/F 111 is a communication interface that is possibly coupled to the control station 101. The inter-unit I/Fs 112 and 113 are communication interfaces each of which is possibly coupled to other units.

The router 114 is coupled to a relay apparatus that is coupled to the inter-control station I/F 111, the inter-unit I/Fs 112 and 113, and the communication unit 115, and performs routing according to a routing table. The communication unit 115 is a communication apparatus that performs transmission and reception of a radio signal through the antenna 116. Furthermore, the communication unit 115 may be configured to perform only one of the transmission of the radio signal and the reception of the radio signal.

The antenna unit 120 includes an inter-control station I/F 121, inter-unit I/Fs 122 and 123, a router 124, a communication unit 125, and an antenna 126. The inter-control station I/F 121, the inter-unit I/Fs 122 and 123, the router 124, the communication unit 125, and the antenna 126 are the same as the inter-control station I/F 111, the inter-unit I/Fs 112 and 113, the router 114, the communication unit 115, and the antenna 116, respectively.

The antenna unit 130 includes an inter-control station I/F 131, inter-unit I/Fs 132 and 133, a router 134, a communication unit 135, and an antenna 136. The inter-control station I/F 131, the inter-unit I/Fs 132 and 133, the router 134, the communication unit 135, and the antenna 136 are the same as the inter-control station I/F 111, the inter-unit I/Fs 112 and 113, the router 114, the communication unit 115, and the antenna 116, respectively.

The antenna unit 140 includes an inter-control station I/F 141, and inter-unit I/Fs 142 and 143, a router 144, a communication unit 145, and an antenna 146. The inter-control station I/F 141, the inter-unit I/F 142 and 143, the router 144, the communication unit 145, and the antenna 146 are the same the inter-control station I/F 111, the inter-unit I/Fs 112 and 113, the router 114, the communication unit 115, and the antenna 116.

As illustrated in FIG. 1, each of the antenna units 110, 120, 130, and 140 has a plurality of inter-unit I/Fs that are possibly coupled to other antenna units (hereinafter also referred to as other units), and is possibly coupled to a plurality of other units. Then, with at least one of the inter-unit I/F and the router of each of the antenna units 110, 120, 130, and 140, the antenna units 110, 120, 130, and 140, communication channels via which the antenna units 110, 120, 130, and 140 possibly communicate with each other are established.

In an example that is illustrated in FIG. 1, the inter-unit I/F 112 of the antenna unit 110 is not coupled to other units, and the inter-unit I/F 113 of the antenna unit 110 is coupled to the inter-unit I/F 122 of the antenna unit 120. Furthermore, the inter-unit I/F 123 of the antenna unit 120 is coupled to the inter-unit I/F 132 of the antenna unit 130. Furthermore, the inter-unit I/F 133 of the antenna unit 130 is coupled to the inter-unit I/F 142 of the antenna unit 140. The inter-unit I/F 143 of the antenna unit 140 is not coupled to other units.

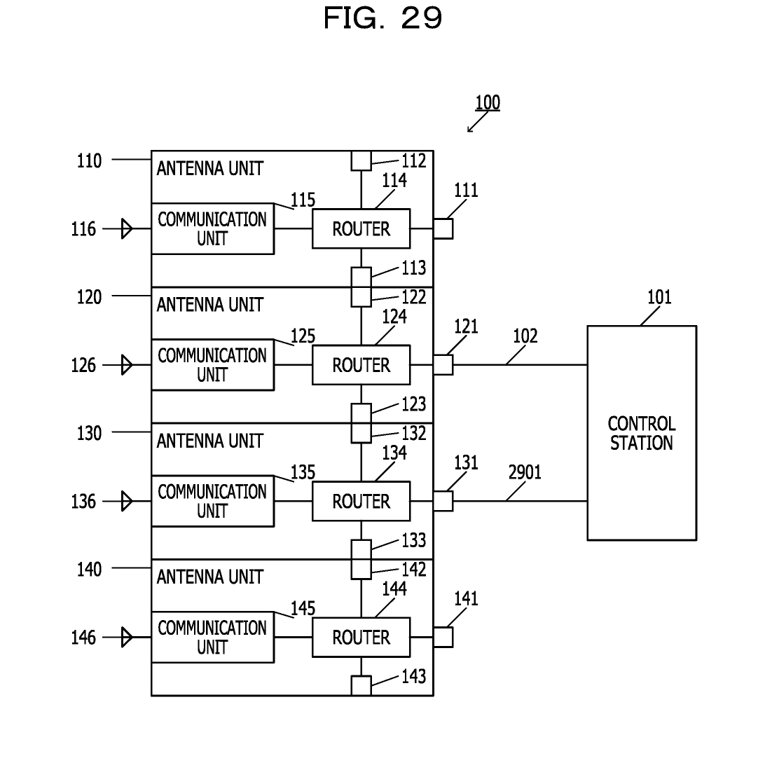

The control station 101 is coupled to one or several of the inter-control station I/Fs 111, 121, 131, and 141. In the example that is illustrated in FIG. 1, the control station 101 is coupled to the inter-control station I/F 121 of the antenna unit 120 through the communication line 102. However, it is possible that a coupling between each of the antenna units 110, 120, 130, and 140 and the control station 101 is not limited to the example that is illustrated in FIG. 1 and is possibly changed flexibly (for example, refer to FIG. 29).

For example, a communication line for a common public radio interface (CPRI) or an open radio equipment interface (ORI) can be used for the communication line 102. However, no limitation to these communication lines are imposed, and various communication lines can be used for the communication line 102.

In the example that is illustrated in FIG. 1, for example, the inter-unit I/F 112 of the antenna unit 110 is not coupled to units. For this reason, a new antenna unit that is the same as each of the antenna units 110, 120, 130, and 140 is coupled to the inter-unit I/F 112, and thus one or more antenna units can be additionally installed in an easy manner. In the same manner, the inter-unit I/F 143 of the antenna unit 140 is not coupled to other units. For this reason, a new antenna unit that is the same as each of the antenna units 110, 120, 130, and 140 is coupled to the inter-unit I/F 143, and thus one or more antenna units can be additionally installed in an easy manner.

Furthermore, because an inter-unit I/F that is not coupled to other units is also present in the newly installed antenna, the antenna unit that is newly, one or more new antenna units can be additionally installed in an easy manner. Furthermore, because, with the inter-unit I/F, the newly installed antenna unit can perform communication with the control station 101 through other units, the new installed antenna unit and the control station 101 may not be coupled to each other with the communication line.

Furthermore, for example, because the antenna unit 110 and the control station 101 is not coupled directly to each other, the antenna unit 110 can be easily removed from the base station apparatus 100. In the same manner, because the antenna unit 140 and the control station 101 is not coupled directly to each other, the antenna unit 140 can be easily removed from the base station apparatus 100.

Furthermore, because a direct coupling between the antenna unit 130 and the control station 101 is not made, both the antenna units 130 and 140 can also be easily from the base station apparatus 100. Furthermore, because the antenna unit that is to be removed is not coupled directly to the control station 101, removing may be performed only between other units, and releasing of the direct coupling to the control station 101, or the like is unnecessary.

In this manner, each antenna unit has a plurality of inter-unit I/Fs and the control station 101 makes the coupling to one or several of the antenna units, and thus the antenna configuration that has a high degree of freedom can be realized. For example, many antenna units that are the same as the antenna units 110, 120, 130, and 140 are manufactured, and any number of antenna units are combined for coupling. Thus, a desired antenna configuration can be realized with efficiency (for example, at low cost). Furthermore, because additional installation of one or more antenna units or removal of the antenna unit can also be performed in an easy manner after installation of the base station apparatus 100, it is possible that the antenna configuration is flexibly changed.

A surface of each of the antenna units 110, 120, 130, and 140, on which the antenna is present, for example, can take the shape of a square pole. Accordingly, the antenna units 110, 120, 130, and 140 can be arranged with efficiency. However, the antenna units 110, 120, 130, and 140 are not limited to this shape, and, for example, may take the shape of a trigonal pyramid, a pentagonal pyramid, or a hexagonal pyramid (a honeycomb structure).

Furthermore, a configuration in which the antenna units 110, 120, 130, and 140 are connected in a two-dimensional shape is described in the example that is illustrated in FIG. 1, but no limitation to this configuration is imposed. For example, in a case where the antenna units 110, 120, 130, and 140 are set to take the shape of a hexagonal pyramid, the inter-unit I/F can be provided on each of the six flank surfaces of each of the antenna units 110, 120, 130, and 140. Accordingly, the antenna units 110, 120, 130, and 140 can be connected in a three-dimensional shape. Furthermore, the antenna units 110, 120, 130, and 140, for example, can be connected with various shapes such as a ring shape, a string shape, or a tree shape.

A configuration in which, as illustrated in FIG. 1, four antenna units (the antenna units 110, 120, 130, and 140) are connected and are included in the base station apparatus 100 will be described below in a focused manner. However, because the additional installation of one or more antenna units or the removal of the antenna unit is possible as described above, the base station apparatus 100 may be configured to include one to three antenna units and may be configured to five or more antenna units, without being limited to this configuration.

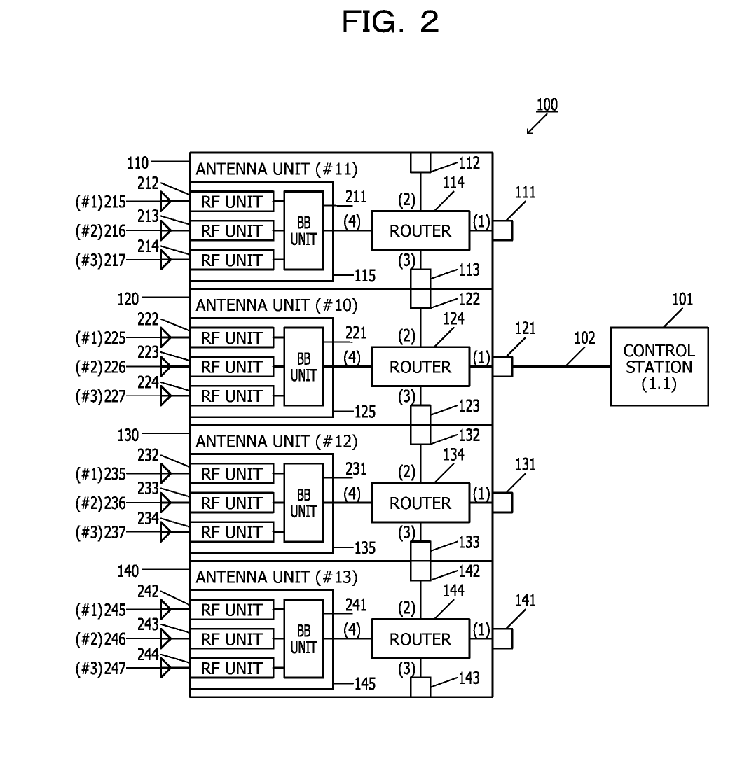

FIG. 2 is a diagram illustrating another example of the base station apparatus according to the embodiment. In FIG. 2, a portion that is the same as the portion that is illustrated in FIG. 1 is given the same reference numeral and a description thereof is omitted. As illustrated in FIG. 2, each of the communication units 115, 125, 135, and 145, for example, can be realized by a RF unit and a BB unit. Furthermore, as illustrated in FIG. 2, each of the antenna units 110, 120, 130, and 140 may be configured to have a plurality of antennas.

For example, in an example that is illustrated in FIG. 2, the communication unit 115 of the antenna unit 110 has a BB unit 211 and RF units 212 to 214. Furthermore, the antenna unit 110 that is illustrated in FIG. 2, has antennas 215 to 217 instead of the antenna 116 that is illustrated in FIG. 1. The BB unit 211 is a baseband processing unit that performs baseband processing for each radio communication which uses the antennas 215 to 217.

The baseband processing by the BB unit 211 on the receiving side includes, for example, demodulation or decoding. The baseband processing by the BB unit 211 on the transmitting side includes, for example, the decoding or the demodulation. The BB unit 211 can be by realized, for example, by a processor, such as a digital signal processor (DSP) or a field programmable gate array (FPGA), or a memory.

The RF units 212 to 214 is provided in a manner that corresponds to the antennas 215 to 217, respectively, and performs radio frequency (RF) (high frequency) processing operations that use the antennas 215 to 217, respectively. The RF processing by each of the RF units 212 to 214 on the receiving side, for example, includes amplification, frequency conversion from a RF band to a baseband, conversion from an analog signal to a digital signal, and the like.

The RF processing by each of the RF units 212 to 214 on the transmitting side, for example, includes conversion form the digital signal to the analog signal, the frequency conversion from the baseband to the RF band, the amplification, and the like. In an example that is illustrated in FIG. 2, #1 to #3 are allocated, as antenna numbers, to the antennas 215 to 217, respectively. The RF units 212 to 214, for example, can be realized by a circuit such as an amplifier, a mixer, or an analog/digital converter.

The communication unit 125 of the antenna unit 120 has a BB unit 221 and RF units 222 to 224. Furthermore, the antenna unit 120 that is illustrated in FIG. 2, has antennas 225 to 227 instead of the antenna 126 that is illustrated in FIG. 1. The BB unit 221, the RF units 222 to 224, and the antennas 225 to 227 are the same as the BB unit 211, the RF units 212 to 214, and the antennas 215 and 217, respectively, of the antenna unit 110. In the example that is illustrated in FIG. 2, #1 to #3 are allocated, as the antenna numbers, to the antennas 225 to 227, respectively.

The communication unit 135 of the antenna unit 130 has a BB unit 231 and RF units 232 to 234. Furthermore, the antenna unit 130 that is illustrated in FIG. 2, has antennas 235 to 237 instead of the antenna 136 that is illustrated in FIG. 1. The BB unit 231, the RF units 232 to 234, and the antennas 235 to 237 are the same as the BB unit 211, the RF units 212 to 214, and the antennas 215 and 217, respectively, of the antenna unit 110. In the example that is illustrated in FIG. 2, #1 to #3 are allocated, as the antenna numbers, to the antennas 235 to 237, respectively.

The communication unit 145 of the antenna unit 140 has a BB unit 241 and RF units 242 to 244. Furthermore, the antenna unit 140 that is illustrated in FIG. 2, has antennas 245 to 247 instead of the antenna 146 that is illustrated in FIG. 1. The BB unit 241, the RF units 242 to 244, and the antennas 245 to 247 are the same as the BB unit 211, the RF units 212 to 214, and the antennas 215 and 217, respectively, of the antenna unit 110. In the example that is illustrated in FIG. 2, #1 to #3 are allocated, as the antenna numbers, to the antennas 245 to 247, respectively.

Furthermore, in the example that is illustrated in FIG. 2, #11, #10, #12, and #13 are allocated, as the unit numbers, to the antenna units 110, 120, 130, and 140, respectively. For example, in a state where the antenna unit 120 is coupled to the control station 101, when the antenna units 110, 130, and 140 are coupled in this order, #10. #11, #12 and #13 are allocated to the antenna units 120, 110, 130, and 140, respectively.

Furthermore, in the example that is illustrated in FIG. 2, for example, port numbers (1) to (4) are allocated to ports of the router 114 in the antenna unit 110. The port number (1) indicates a port that is coupled to the inter-control station I/F 111, among ports (output ports) of the router 114. The port number (2) indicates a port that is coupled to the inter-unit I/F 112, among the ports of the router 114. The port number (3) indicates a port that is coupled to the inter-unit I/F 113, among the ports of router 114. The port number (4) indicates a port that is coupled to the communication unit 115, among the ports of router 114. As is the case with the router 114 of the antenna unit 110, the port numbers (1) to (4) are allocated to ports of each of the antenna units 120, 130, and 140.

Furthermore, it is assumed that “1.1” is allocated, as an address, to the control station 101. It is noted that a configuration in which each of the antenna units 110, 120, 130, and 140 has three antennas is described, but that no limitation to this configuration is imposed. For example, the number of antennas that each of the antenna units 110, 120, 130, and 140 has may be 1 (refer to FIG. 1), 2, or 4 or greater. Furthermore, the number of antennas that each of the antenna units 110, 120, 130, and 140 has may vary among the antenna units themselves.

In the base station apparatus 100, for example, the antenna units 110, 120, 130, and 140 that are coupled can be set to be one remote radio head (RRH) (a radio unit). Furthermore, the control station 101, for example, can be set to be a centralized-base band unit (C-BBU).

Beamforming

Next, beamforming that uses the antenna units 110, 120, 130, and 140 will be described. For example, when performing beamforming using MIMO between the base station apparatus 100 and a mobile station which performs communication with the base station apparatus 100, the control station 101 determines which antenna is used for radio communication with the mobile station. The antennas to use may be the same or may be different from each other for an uplink signal and s downlink signal. A case where the antennas are the same for the uplink signal and the downlink signal is described here.

Furthermore, the control station 101 determines a weighing coefficient for beamforming, for each antenna that is determined as the antenna to use. An example of the weighting coefficient for beamforming is a precoding matrix indicator (PMI). Then, the control station 101 transmits to the antenna unit 120 not only control information indicating the antenna to use and the weighting coefficient for beamforming, but also data destined for the mobile station. Accordingly, with the routing, the data destined for the mobile station is transferred to each antenna unit that has the antenna to use, and data on which weighting is performed by the antenna unit is simultaneously transmitted through a plurality of antennas.

Furthermore, in a case where the beamforming is also performed for the uplink signal, with transmission of a control signal, the control station 101 notifies the mobile station of the antenna to use and the weighting coefficient for beamforming. Accordingly, radio transmission of the uplink signal from the mobile station to the base station apparatus 100, which uses beamforming, is performed. The control station 101 performs combination processing based on the antenna and the weighting coefficient for beamforming, which are notified to the mobile station, and thus can composite uplink signals that are transmitted using the beamforming.

Processing at Startup

Next, processing at startup by the base station apparatus 100 when connecting a plurality of antenna units will be described. For example, in a configuration that is illustrated in FIG. 1, the antenna unit 120 that is coupled (interfaced) to the control station 101 operates as a master unit. The antenna unit 120 that operates as the master unit registers unit numbers of the antenna units 110 and 130 that are coupled to the inter-unit I/Fs 122 and 123 of the router 124. Accordingly, the data that is received from the control station 101 can be assigned from the antenna unit 120 to a desired antenna unit.

Furthermore, unit numbers of other units that are coupled directly or indirectly to each of the inter-unit I/Fs are also registered with other antenna units (the antenna unit 110, 130, and 140). A result of the registration by each antenna unit at startup, for example, is stored, as a routing table, in a memory of each antenna unit.

As described above, it is possible that a configuration of antenna units that are connected and that data is transferred to any antenna number. Furthermore, a received signal of the base station apparatus 100 is transferred toward the master unit. Furthermore, an entire connection configuration is known from an adjacent antenna unit, and thus it is also possible that an entire connection situation can be known in the control station 101.

Example of Routing Table for the Antenna Unit

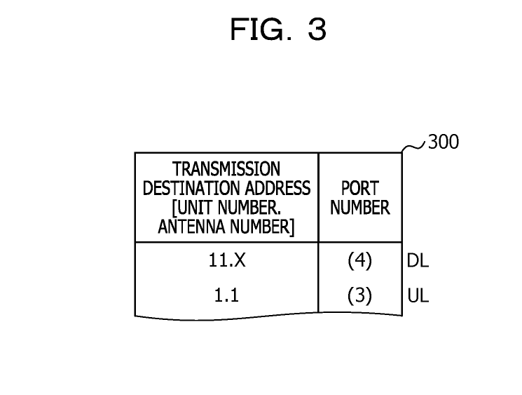

FIG. 3 is a diagram illustrating an example of a routing table for an antenna unit (#11) according to the embodiment. It is possible that the router 114 of the antenna unit 110 of which a unit number is #11, for example, has access to a routing table 300 that is illustrated in FIG. 3. The routing table 300, for example, is stored in a memory that is included in the antenna unit 110.

The routing table 300 is a routing table in which a port number indicating a port of an output destination of a packet, among ports of the router 114 is associated with every transmission destination address of the packet. For example, in the base station apparatus 100, a format that is [unit number.antenna number] is used as a format of a transmission destination address of a downlink (DL) packet in downlink, which is a packet that is transmitted by the base station apparatus 100. Furthermore, in the base station apparatus 100, a transmission destination address of an uplink (UL) packet, which is a packet that is received by the base station apparatus 100, is “1.1” indicating the control station 101.

In the routing table 300, the port number (4) is associated with a transmission destination address “11.X” indicating any antenna in the antenna unit 110 (a unit number #11). Accordingly, the router 114 can transfer the DL packet which a transmission destination is an antenna of the antenna unit 110, to the communication unit 115.

Furthermore, in the routing table 300, the port number (3) is associated with the transmission destination address “1.1” indicating the control station 101. Accordingly, the router 114 can transfer the UL packet of which a transmission destination is the control station 101, to the antenna unit 120 through the inter-unit I/F 113.

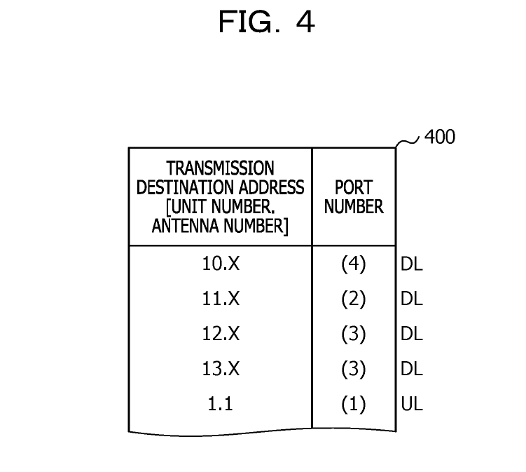

FIG. 4 is a diagram illustrating an example of a routing table for the antenna unit (#10) according to the embodiment. In FIG. 4, a description of a portion that is the same as the portion that is illustrated in FIG. 3 is omitted. It is possible that the router 124 of the antenna unit 120 of which a unit number is #10, for example, has access to a routing table 400 that is illustrated in FIG. 4. The routing table 400, for example, is stored in a memory that is included in the antenna unit 120. The routing table 400 is a routing table in which a port number indicating a port of an output destination of a packet, among ports of the router 124 is associated with every transmission destination address of the packet.

In the routing table 400, the port number (4) is associated with a transmission destination address “10.X” indicating any antenna in the antenna unit 120 (a unit number #10). Accordingly, the router 124 can transfer the DL packet in DL of which the transmission destination is an antenna of the antenna unit 120, to the communication unit 125.

Furthermore, in the routing table 400, the port number (2) is associated with a transmission destination address “11.X” indicating any antenna in the antenna unit 110 (a unit number #11). Accordingly, the router 124 can transfer the DL packet of which the transmission destination is an antenna of the antenna unit 110, to the antenna unit 110 through the inter-unit I/F 122.

Furthermore, in the routing table 400, the port number (3) is associated with a transmission destination address “12.X” indicating any antenna in the antenna unit 130 (a unit number #12). Accordingly, the router 124 can transfer the DL packet of which the transmission destination is an antenna of the antenna unit 130, to the antenna unit 130 through the inter-unit I/F 123.

Furthermore, in the routing table 400, the port number (3) is associated with a transmission destination address “13.X” indicating any antenna in the antenna unit 140 (a unit number #13). Accordingly, the router 124 can transfer the DL packet in DL which the transmission destination is an antenna of the antenna unit 140, to the antenna unit 130 through the inter-unit I/F 123.

Furthermore, in the routing table 400, the port number (1) is associated with the transmission destination address “1.1” indicating the control station 101. Accordingly, the router 124 can transfer the UL packet in UL of which the transmission destination is the control station 101, to the control station 101 through the inter-control station I/F 121.

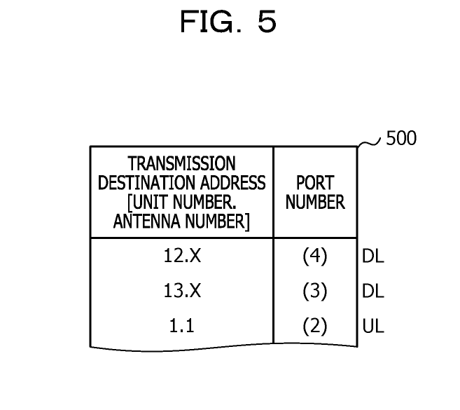

FIG. 5 is a diagram illustrating an example of a routing table for the antenna unit (#12) according to the embodiment. In FIG. 5, a description of a portion that is the same as the portion that is illustrated in FIGS. 3 and 4 is omitted. It is possible that the router 134 of the antenna unit 130 of which a unit number is #12, for example, has access to a routing table 500 that is illustrated in FIG. 5. The routing table 500, for example, is stored in a memory that is included in the antenna unit 130. The routing table 500 is a routing table in which a port number indicating a port of an output destination of a packet, among ports of the router 134 is associated with every transmission destination address of the packet.

In the routing table 500, the port number (4) is associated with a transmission destination address “12.X” indicating any antenna in the antenna unit 130 (a unit number #12). Accordingly, the router 134 can transfer the DL packet which the transmission destination is an antenna of the antenna unit 130, to the communication unit 135.

Furthermore, in the routing table 500, the port number (3) is associated with a transmission destination address “13.X” indicating any antenna in the antenna unit 140 (a unit number #13). Accordingly, the router 134 can transfer the DL packet in DL of which the transmission destination is an antenna of the antenna unit 140, to the antenna unit 140 through the inter-unit I/F 133.

Furthermore, in the routing table 500, the port number (2) is associated with the transmission destination address “1.1” indicating the control station 101. Accordingly, the router 134 can transfer the UL packet of which the transmission destination is the control station 101, to the antenna unit 120 through the inter-unit I/F 132.

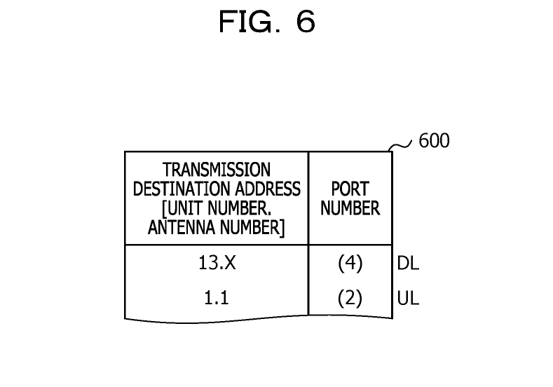

FIG. 6 is a diagram illustrating an example of a routing table for the antenna unit (#13) according to the embodiment. In FIG. 6, a description of a portion that is the same as the portion that is illustrated in FIGS. 3 to 5 is omitted. It is possible that the router 144 of the antenna unit 140 of which a unit number is #13, for example, has access to a routing table 600 that is illustrated in FIG. 6. The routing table 600, for example, is stored in a memory that is included in the antenna unit 140. The routing table 600 is a routing table in which a port number indicating a port of an output destination of a packet, among ports of the router 144 is associated with every transmission destination address of the packet.

In the routing table 600, the port number (4) is associated with a transmission destination address “13.X” indicating any antenna in the antenna unit 140 (a unit number #13). Accordingly, the router 144 can transfer the DL packet of which the transmission destination is an antenna of the antenna unit 140, to the communication unit 145.

Furthermore, in the routing table 600, the port number (2) is associated with the transmission destination address “1.1” indicating the control station 101. Accordingly, the router 144 can transfer the UL packet in UL of which the transmission destination is the control station 101, to the antenna unit 130 through the inter-unit I/F 142.

Example of the Router

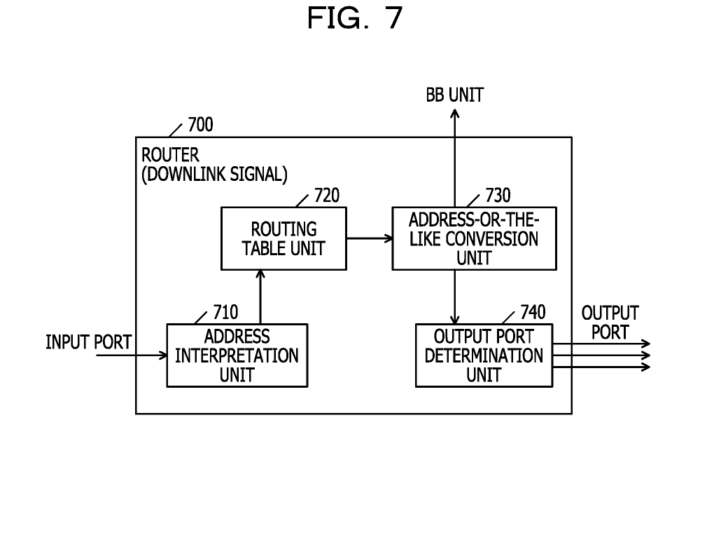

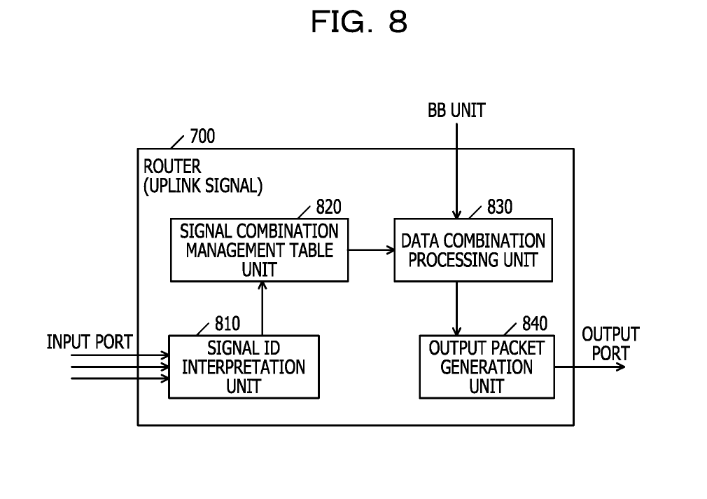

FIG. 7 is a diagram illustrating an example of a configuration relating to the downlink signal of the router according to the embodiment. Each of the routers 114, 124, 134, and 144, for example, can be realized by router 700 that is illustrated in FIGS. 7 and 8. As illustrated in FIG. 7, as a configuration relating to the downlink signal, the router 700 has an address interpretation unit 710, a routing table unit 720, an address-or-the-like conversion unit 730, and an output port determination unit 740.

The address interpretation unit 710 interprets transmission destination address of a packet, which is input from an input port of the router 700 in DL. For example, a port between the router 700 and the inter-control station I/F (for example, the inter-control station I/F 111) described above or a port between the router 700 and the inter-unit I/F (for example, the inter-unit I/F 112 or 113) described above is included in the input port in DL. The routing table unit 720 accesses, for example, a routing table as illustrated in FIGS. 3 to 6 and specifies a port number that corresponds to a transmission destination address that is interpreted by the address interpretation unit 710.

In a case where an output destination of a port number that is specified by the routing table unit 720 is a BB unit, the address-or-the-like conversion unit 730 converts the transmission destination address or the like and outputs a result of the conversion to the BB unit. The transmission destination address and the like, for example, includes deletion of the unit number that is included in the transmission destination address of the packet, and so forth.

In a case where an output destination of a port number that is specified by the routing table unit 720 is one other unit, the output port determination unit 740 determines a port of an output destination, among ports that correspond to a plurality of inter-unit I/Fs that are coupled to the router 700. Then, the output port determination unit 740 outputs a packet from a port (an output port) that is determined as the output destination, and thus transfers a packet that is input into the router 700, to other units.

In this manner, the router 700 has a configuration in which the downlink signal that is transmitted from the control station 101 is sent to any antenna of any antenna unit. Furthermore, the router 700 has a function of delivering the same data to a plurality of antennas of one or more antenna unit. This is for realizing transmission beamforming by performing transmission after delivering and weighting a signal.

FIG. 8 is a diagram illustrating an example of a configuration relating to the uplink signal of the router according to the embodiment. As illustrated in FIG. 8, as a configuration relating to the uplink signal, the router 700 has a signal ID interpretation 810, a signal combination management table unit 820, a data combination processing unit 830, and an output packet generation unit 840.

The signal ID interpretation 810 interprets a signal ID of a packet that is input from a UL input port of the router 700. For example, a port between the router 700 and the inter-unit I/F (for example, the inter-unit I/F 112 or 113) described above is included in the UL input port. The signal ID, for example, is a stream ID that identifies a stream of data. The signal combination management table unit 820 has access to a signal combination management table that possibly specifies an antenna unit which composites pieces of data that are received from a plurality of antennas, and determines whether or not pieces of data in packets that are input are composited in the antenna unit.

Based on a result of the determination by the signal combination management table unit 820, the data combination processing unit 830 performs combination of the pieces of data in the packet that are input. For example, in a case where the combination processing is performed, the data combination processing unit 830 performs gathering of pieces of data that have the same signal ID (streaming ID) that is interpreted by the signal ID interpretation 810, and performs combination (addition) of pieces of data that have the same signal ID (streaming ID). Pieces of data that are composited by the data combination processing unit 830 include pieces of data (pieces of data that are wirelessly received by other units) that is input from a UL input port which is described above, or data (data is wirelessly received by the unit) that is input from the BB unit of the antenna unit).

The output packet generation unit 840 generates pieces of data that are composited by the data combination processing unit 830, or a UL input packet or a packet (an output packet) that includes pieces of data which are not composited by the data combination processing unit 830, which are input from the BB unit of the antenna unit. Then, the output packet generation unit 840 outputs the generated packet to a prescribed output port. The outputting of the packet from the output port by the output packet generation unit 840, for example, may be performed based on a routing table as illustrated in FIGS. 3 to 6, and may be performed by an output destination port that is set in advance for the output packet generation unit 840.

In this manner, the router 700 has a function in which the uplink signal that is received in any antenna element of any antenna unit is sent to the control station 101. Furthermore, the router 700 has a function of processing signals received by a plurality of antennas of one or more antenna units in a composited manner and then performing routing on the resulting signals. This is for realizing reception beamforming or one portion of the reception beamforming.

Example of a Configuration of the BB Unit

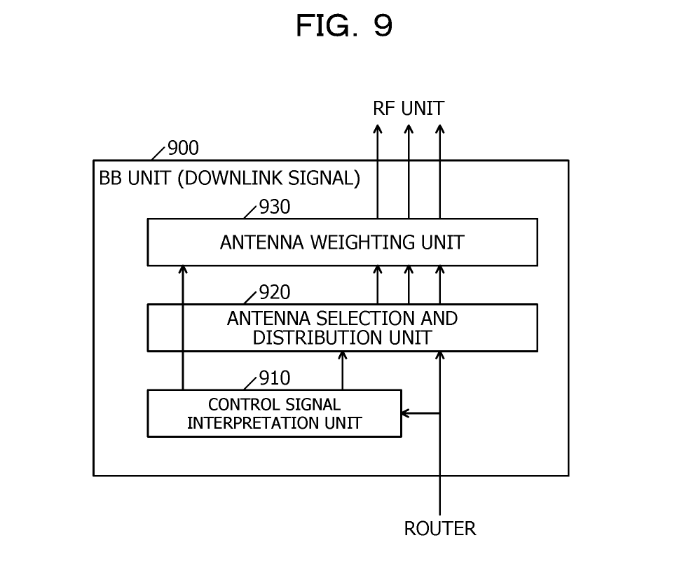

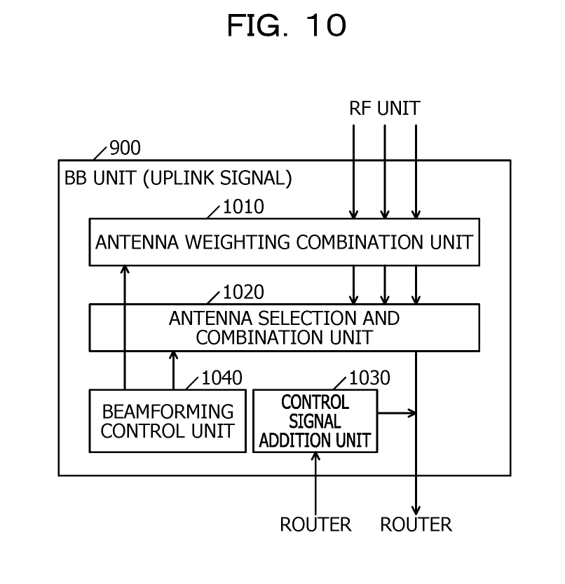

FIG. 9 is a diagram illustrating an example of a configuration relating to the downlink signal of the BB unit according to the embodiment. Each of the BB units 211, 221, 231, and 241, for example, can be realized by a BB unit 900 that is illustrated in FIGS. 9 and 10. As illustrated in FIG. 8, as the configuration relating to the downlink signal, the BB unit 900 has a control signal interpretation unit 910, an antenna selection and distribution unit 920, and an antenna weighting unit 930.

The control signal interpretation unit 910 performs interpretation of the control signal that is included in the packet which is transferred from the router of the antenna unit. For example, an antenna number of antenna of a transmission destination, a weighting coefficient (weight) for beamforming that corresponds to the antenna of the transmission destination, or the like is included in the control signal that is interpreted by the control signal interpretation unit 910.

The antenna selection and distribution unit 920 selects the antenna of the transmission destination of the packet that is transferred from the router of the antenna unit, based on the antenna number that is included in the control signal which is interpreted by the control signal interpretation unit 910. Then, the antenna selection and distribution unit 920 distributes data in a packet that is transferred from the router of the antenna unit to a channel that corresponds to the selected transmission destination, and outputs the resulting data. The channel that corresponds to the selected transmission destination, for example, is a channel that is coupled to a RF which corresponds to the antenna of the selected transmission destination.

The antenna weighting unit 930 weights (multiplies) the data that is distributed and output by the antenna selection and distribution unit 920, based on the weight that is included in the control signal which is interpreted by the control signal interpretation unit 910, and outputs the resulting data to the RF unit of the antenna unit. Accordingly, the weighted data can be wirelessly transmitted from the antenna of the antenna unit, and downlink beamforming can be performed.

FIG. 10 is a diagram illustrating an example of a configuration relating to the uplink signal of the BB unit according to the embodiment. As illustrated in FIG. 10, as the configuration relating to the uplink signal, the BB unit 900 has an antenna weighting combination unit 1010, an antenna selection and combination unit 1020, a control signal addition unit 1030, and a beamforming control unit 1040.

The antenna weighting combination unit 1010 weighting-composites (weighting-adds) piece of data that are received by the antennas, respectively, of the antenna unit, under the control of the beamforming control unit 1040, and outputs the resulting data to the antenna selection and combination unit 1020. The antenna selection and combination unit 1020 composites (adds) the pieces of data that are weighting-composited by the antenna weighting combination unit 1010, under the control of the beamforming control unit 1040, and transfers data that is obtained by the addition, to the router of the antenna unit.

The control signal addition unit 1030 adds a control signal to the data that is transferred by the antenna selection and combination unit 1020 to the router of the antenna unit. For example, the control signal addition unit 1030 adds the control signal such as the signal ID (the streaming ID) to the data.

This control information, for example, can be added based on a result of scheduling that is performed by the control station 101. For example, the BB unit 900 can obtain the result of the scheduling that is performed by the control station 101, from the control station 101 through the router of the antenna unit. Furthermore, the control information that is added by the control signal addition unit 1030 may be an address of the control station 101 that is the transmission destination, a unit number of the antenna unit that is coupled to the control station 101, or the like.

The beamforming control unit 1040 controls the weighting-compositing by the antenna weighting combination unit 1010 and the combination by the antenna selection and the combination unit 1020. For example, as is the case with the downlink signal, the same beamforming is set to be performed on the uplink signal. In this case, the beamforming control unit 1040 performs control of the antenna weighting combination unit 1010 and the antenna selection and combination unit 1020, using a control parameter that corresponds to a control parameter which is a result from the control signal interpretation unit 910 that is illustrated in FIG. 9. Included in the control parameter is an antenna number of the antenna that is used for the transmission and reception of the radio signal, weight that corresponds to the antenna that is used for the transmission and reception of the radio signal, or the like.

Transmission Channel in the Base Station Apparatus According to the Embodiment

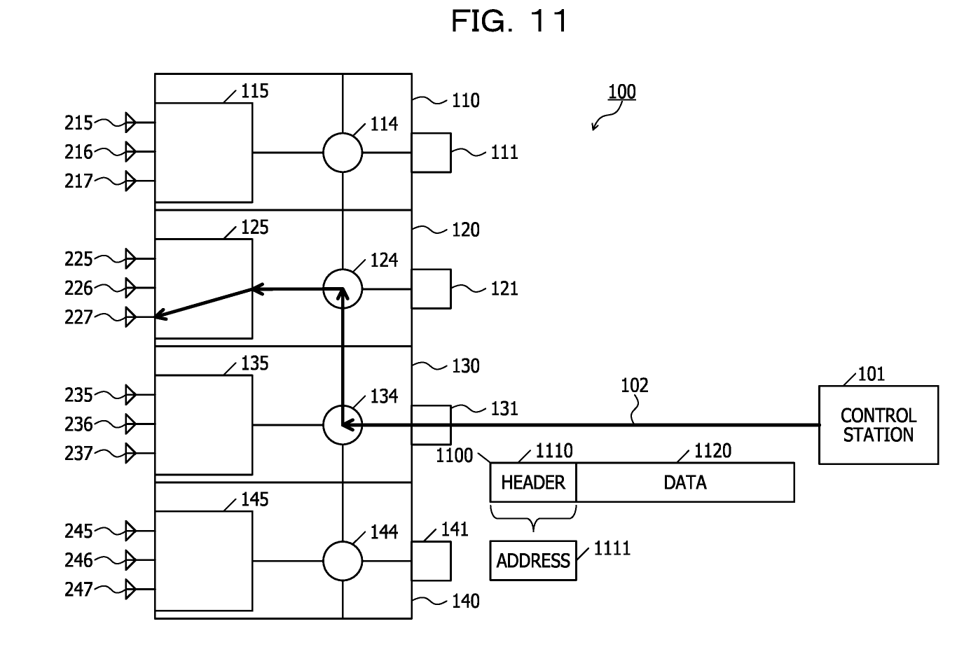

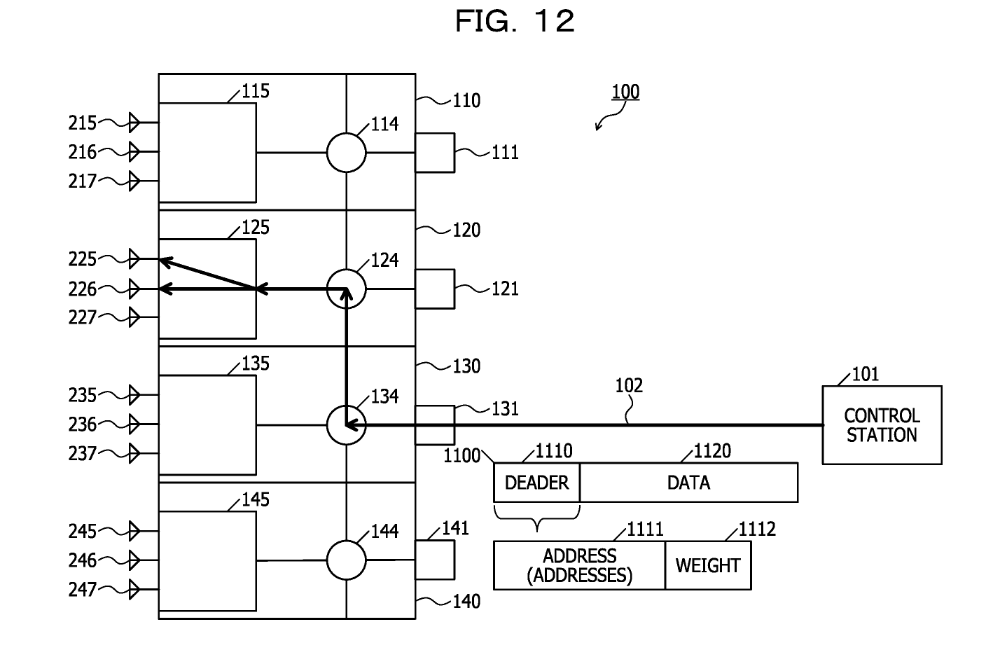

FIG. 11 is a diagram illustrating an example of a transmission channel, for which a single unit and a single antenna in the base station apparatus according to the embodiment are used. In FIG. 11, a portion that is the same as the portion that is illustrated in FIG. 2 is given the same reference numeral and a description thereof is omitted. However, in FIG. 11, illustrations of the inter-unit I/F, the BB unit, and the RF unit are omitted. Furthermore, in an example that is illustrated in FIG. 11, the control station 101 is coupled to the inter-control station I/F 131 of the antenna unit 130 through the communication line 102. This is also true for FIGS. 12 to 18.

A transmitted signal 1100 is a DL packet (a signal in a time domain) that is transmitted by the control station 101 to the antenna unit 130 through the communication line 102. A transmitted signal 1100 includes a header 1110 and data 1120. The header 1110, for example, is a header that is added by the control station 101, and includes an address 1111. The address 1111 is a transmission destination address (identification information) indicating an antenna of a transmission destination, among antennas of each of the antenna units 110, 120, 130, and 140.

In the example that is illustrated in FIG. 11, the address 1111 is set to be an address (for example, “10.3”) indicating an antenna 227 of the antenna unit 120. That is, in the example that is illustrated in FIG. 11, transmission that uses stream delivery to a single unit and a single antenna is performed. The data 1120 is user data that is transmitted in DL.

The transmitted signal 1100, which is transmitted from the control station 101, is input into the router 134 through the inter-control station I/F 131 of the antenna unit 130. Based on the address 1111 of the transmitted signal 1100 and the routing table 500 (refer to FIG. 5), the router 134 transfers the transmitted signal 1100 to the antenna unit 120.

The transmitted signal 1100, which is transferred from the antenna unit 130 to the antenna unit 120, is input into the router 124 of the antenna unit 120. Based on the address 1111 of the transmitted signal 1100 and the routing table 400 (refer to FIG. 4), the router 124 transfers the transmitted signal 1100 to the communication unit 125. The communication unit 125 transmits the data 1120 of the transmitted signal 1100 that is transferred from the router 124, from the antenna 227 based on the address 1111.

FIG. 12 is a diagram illustrating an example of a transmission channel, for which a single unit and a plurality of antennas in the base station apparatus according to the embodiment are used. In FIG. 12, a portion that is the same as the portion that is illustrated in FIG. 11 is given the same reference numeral and a description thereof is omitted. In an example that is illustrated in FIG. 12, a plurality of addresses (for example, “10.1” and “10.2”) indicating antennas 225 and 226, respectively, of the antenna unit 120 are set for the address 1111. That is, in the example that is illustrated in FIG. 12, transmission that uses stream delivery to a single unit and a plurality of antennas is performed.

Furthermore, in the example that is illustrated in FIG. 12, the address 1111 and weight 1112 are included in the transmitted signal 1100. In a case where the address 1111 indicates a plurality of antennas, the weight 1112 is information indicating a weighting coefficient between each of the plurality of antennas. The communication unit 125 distributes the data 1120 of the transmitted signal 1100, which is transferred from the router 124, to the antennas 225 and 226 based on the address 1111, and transmits the resulting data 1120. Furthermore, the communication unit 125 weights a signal that is transmitted from each of the antenna 225 and 226, based on the weight 1112.

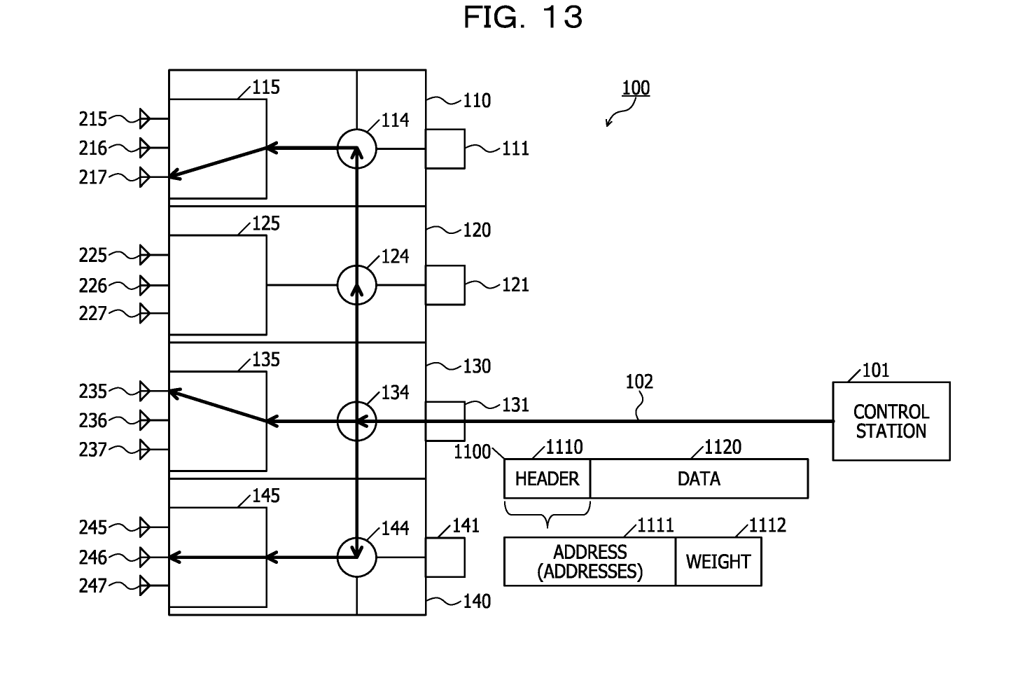

FIG. 13 is a diagram illustrating an example of a transmission channel, for which a plurality of units and a single antenna in the base station apparatus according to the embodiment are used. In FIG. 13, a portion that is the same as the portion that is illustrated in FIG. 12 is given the same reference numeral and a description thereof is omitted. In an example that is illustrated in FIG. 13, a plurality of addresses (for example, “11.3,” “12.1,” and “13.2”) indicating antennas 217, 235, and 246, respectively, are set for the address 1111. That is, in the example that is illustrated in FIG. 13, transmission that uses stream delivery to a plurality of units and a single antenna is performed.

The router 134 of the antenna unit 130 transfers the transmitted signal 1100 to the communication unit 135 and the antenna units 120 and 140 based on the address 1111 of the transmitted signal 1100 and the routing table 500 (refer to FIG. 5). The communication unit 135 transmits the data 1120 of the transmitted signal 1100, which is transferred from the router 134, from the antenna 235 based on the address 1111. Furthermore, the communication unit 135 weights the data 1120 using a coefficient of the antenna 235 that is included in the weight 1112, and transmits the resulting data 1120 from the antenna 235.

The router 124 of the antenna unit 120 transfers the transmitted signal 1100, which is transferred from the antenna unit 130, to the antenna unit 110 based on the address 1111 of the transmitted signal 1100 and the routing table 400 (refer to FIG. 4).

The router 114 of the antenna unit 110 transfers the transmitted signal 1100, which is transferred from the antenna unit 120, to the communication unit 115 based on the address 1111 of the transmitted signal 1100 and the routing table 300 (refer to FIG. 3). The communication unit 115 transmits the data 1120 of the transmitted signal 1100, which is transferred from the router 114, from the antenna 217 based on the address 1111. Furthermore, the communication unit 115 weights the data 1120 using a coefficient of the antenna 217 that is included in the weight 1112, and transmits the resulting data 1120 from the antenna 217.

The router 144 of the antenna unit 140 transfers the transmitted signal 1100, which is transferred from the antenna unit 130, to the communication unit 145 based on the address 1111 of the transmitted signal 1100 and the routing table 600 (refer to FIG. 6). The communication unit 145 transmits the data 1120 of the transmitted signal 1100, which is transferred from the router 144, from the antenna 246 based on the address 1111. Furthermore, the communication unit 145 weights the data 1120 using a coefficient of the antenna 246 that is included in the weight 1112, and transmits the resulting data 1120 from the antenna 246.

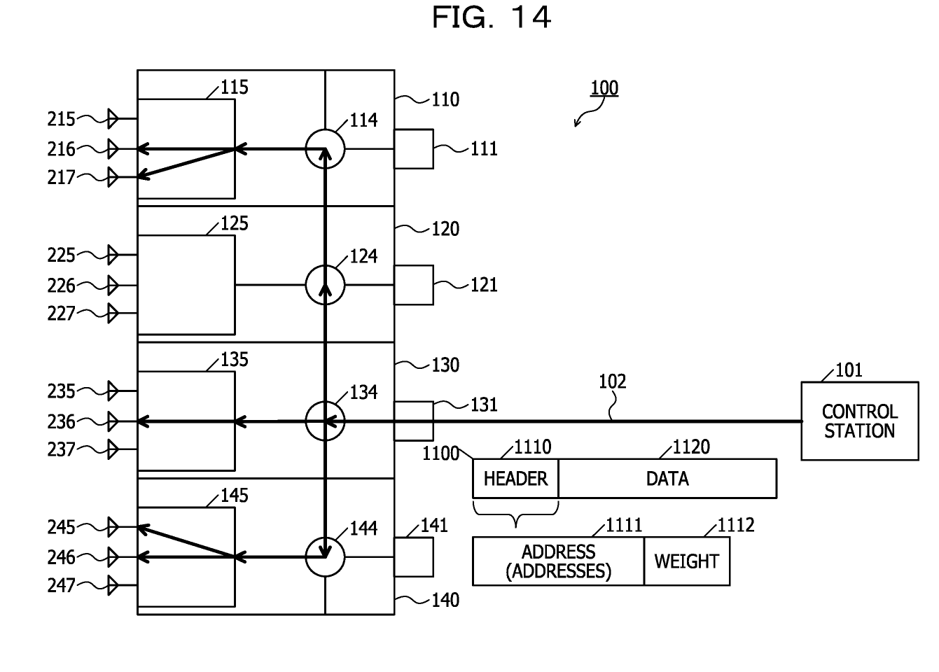

FIG. 14 is a diagram illustrating an example of a transmission channel, for which a plurality of units and a plurality of antennas in the base station apparatus according to the embodiment are used. In FIG. 14, a portion that is the same as the portion that is illustrated in FIG. 13 is given the same reference numeral and a description thereof is omitted. In an example that is illustrated in FIG. 14, a plurality of antennas (for example, “11.2,” “11.3,” “12.2,” “13.1,” and “13.2”) indicating addresses 216, 217, 236, 245, and 246, respectively, are set for the address 1111. That is, in the example that is illustrated in FIG. 14, transmission that uses stream delivery to a plurality of units and a plurality of antennas is performed.

The communication unit 135 of the antenna unit 130 transmits the data 1120 of the transmitted signal 1100, which is transferred from the router 134, from the antenna 236 based on the address 1111. Furthermore, the communication unit 135 weights the data 1120 using a coefficient of the antenna 236 that is included in the weight 1112, and transmits the resulting data 1120 from the antenna 236.

The communication unit 115 of the antenna unit 110 transmits the data 1120 of the transmitted signal 1100, which is transferred from the router 114, from the antennas 216 and 217 based on the address 1111. Furthermore, the communication unit 115 weights the data 1120 using a coefficient of each of the antennas 216 and 217, which is included in the weight 1112 and transmits the resulting data 1120 from the antennas 216 and 217.

The communication unit 145 of the antenna unit 140 transmits the data 1120 of the transmitted signal 1100, which is transferred from the router 144, from the antennas 245 and 246 based on the address 1111. Furthermore, the communication unit 145 weights the data 1120 using a coefficient of each of the antennas 245 and 246, which is included in the weight 1112, and transmits the resulting data 1120 from the antennas 245 and 246.

As illustrated in FIGS. 11 to 14, the control station 101 transmits a transmitted signal, which is transmitted through radio communication, to an antenna unit that has an antenna which is used for the transmission through the radio communication, via a communication channel between the communication line 102 and the antenna unit. In contrast, among the antenna units 110, 120, 130, and 140, the antenna unit that has the antenna which is used for the transmission through the radio communication wirelessly transmits the data that is included in the transmitted signal, which is transmitted from the control station 101, from an antenna of the antenna unit.

Accordingly, although a configuration is employed in which the control station 101 is coupled to only one or several of the antenna units 110, 120, 130, and 140, the control station 101 can perform the radio transmission that uses a plurality of antennas of the antenna units 110, 120, 130, and 140.

Reception Channel in the Base Station Apparatus According to the Embodiment

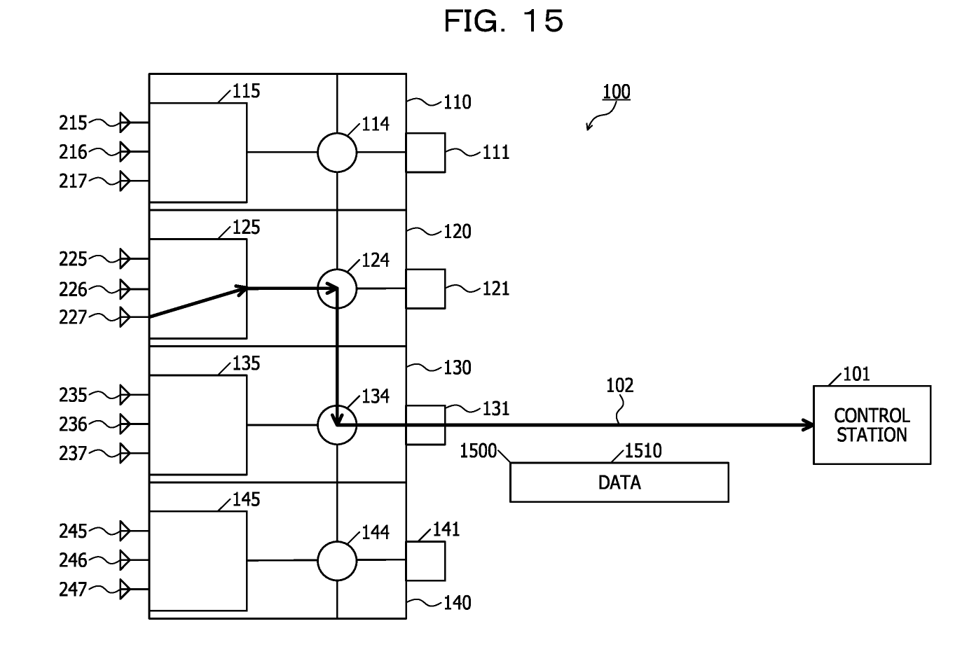

FIG. 15 is a diagram illustrating an example of a reception channel, for which a single unit and a single antenna in the base station apparatus according to the embodiment are used. In FIG. 15, a portion that is the same as the portion that is illustrated in FIG. 11 is given the same reference numeral and a description thereof is omitted. In an example that is illustrated FIG. 15, in the reverse direction to that of the channel that is illustrated in FIG. 11, the base station apparatus 100 receives UL data through the antenna 227. That is, in the example that is illustrated in FIG. 15, reception that uses a single antenna and acceptance of a stream from a single unit are performed.

The communication unit 125 of the antenna unit 120 transfers data that is received by the antenna 227, to the router 124. The router 124 adds the address “1.1” of the control station 101, as a transmission destination address, to the data that is transferred from the communication unit 125. Then, the router 124 transfers the data to the antenna unit 130, based on the added address “1.1” and the routing table 400 (refer to FIG. 4).

The router 134 of the antenna unit 130 transfers the data that is transferred from the antenna unit 120, to the control station 101 based on the added address “1.1” and the routing table 500 (refer to FIG. 5). At this time, the router 134 may delete the address “1.1” and may transfer the deleted data to the control station 101.

A received signal 1500 is a received signal (a signal in the time domain) that is transferred from the antenna unit 130 to the control station 101. The received signal 1500 includes data 1510. The data 1510 is user data that is transmitted in UL.

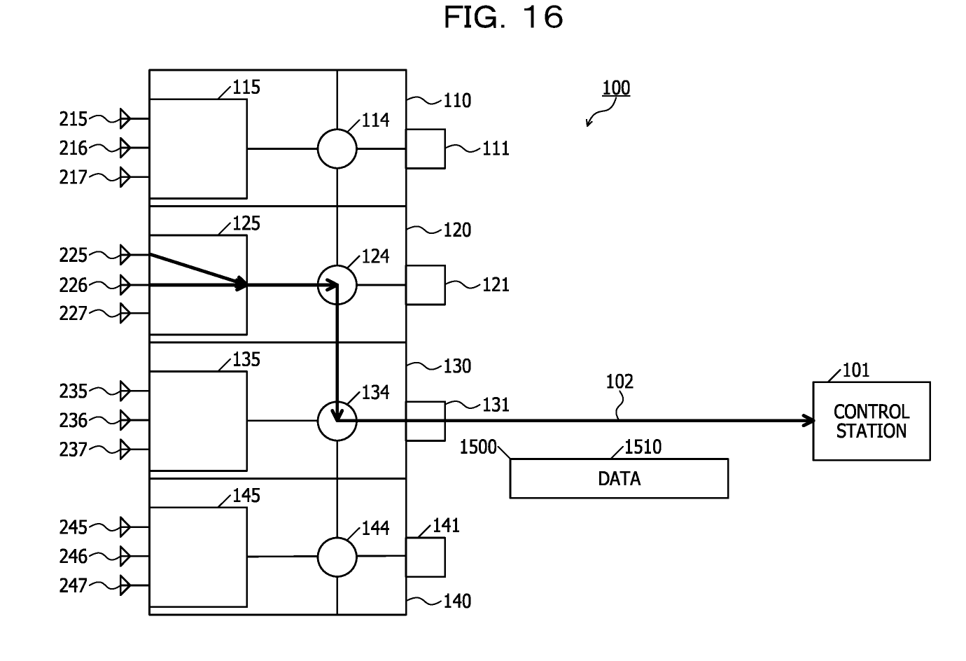

FIG. 16 is a diagram illustrating an example of a reception channel, for which a single unit and a plurality of antennas in the base station apparatus according to the embodiment are used. In FIG. 16, a portion that is the same as the portion that is illustrated in FIG. 15 is given the same reference numeral and a description thereof is omitted. In an example that is illustrated FIG. 16, in the reverse direction to that of the channel that is illustrated in FIG. 12, the base station apparatus 100 receives the UL data through the antennas 225 and 226. That is, in the example that is illustrated in FIG. 16, reception that uses a plurality of antennas and acceptance of a stream from a single unit are performed.

The communication unit 125 of the antenna unit 120 weighting-composites (weighting-adds) pieces of data that are received by the antennas 225 and 226. Then, the communication unit 125 transfers the data that is obtained by the weighting combination, to the router 124.

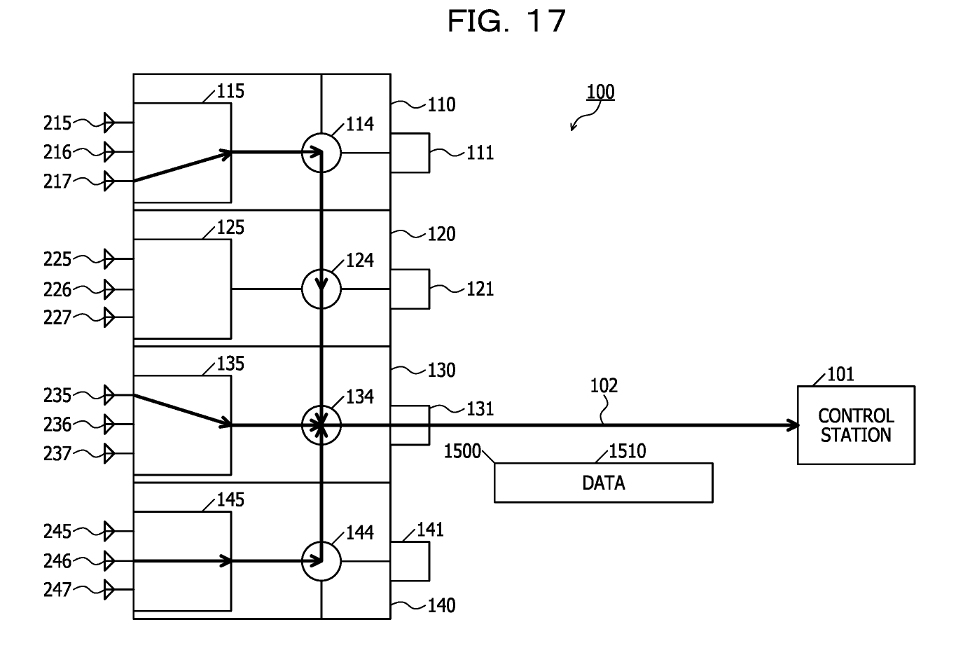

FIG. 17 is a diagram illustrating an example of a reception channel, for which a plurality of units and a single antenna in the base station apparatus according to the embodiment are used. In FIG. 17, a portion that is the same as the portion that is illustrated in FIG. 16 is given the same reference numeral and a description thereof is omitted. In an example that is illustrated FIG. 17, in the reverse direction to that of the channel that is illustrated in FIG. 13, the base station apparatus 100 receives the UL data through the antennas 217, 235, and 246. That is, in the example that is illustrated in FIG. 17, reception that uses a single antenna and acceptance of a stream from a plurality of units are performed.

The communication unit 115 of the antenna unit 110 transfers data that is received by the antenna 217, to the router 114. The router 114 adds the address “1.1” of the control station 101, as a transmission destination address, to the data that is transferred from the communication unit 115. Then, the router 114 transfers the data to the antenna unit 120, based on the added address “1.1” and the routing table 300 (refer to FIG. 3).

The router 124 of the antenna unit 120 transfers the data that is transferred from the antenna unit 110, to the antenna unit 130, based on the address “1.1” added to the data and the routing table 400 (refer to FIG. 4).

The communication unit 135 of the antenna unit 130 transfers data that is received by the antenna 235, to the router 134. The router 134 weighting-composites the data that is transferred from the communication unit 135 and the data that is transferred from the antenna unit 120. Furthermore, the router 134 transfers the data that is obtained by the weighting combination, to the control station 101, based on the address “1.1” and the routing table 500 (refer to FIG. 5). At this time, the router 134 may delete the address “1.1” and may transfer the deleted data to the control station 101.

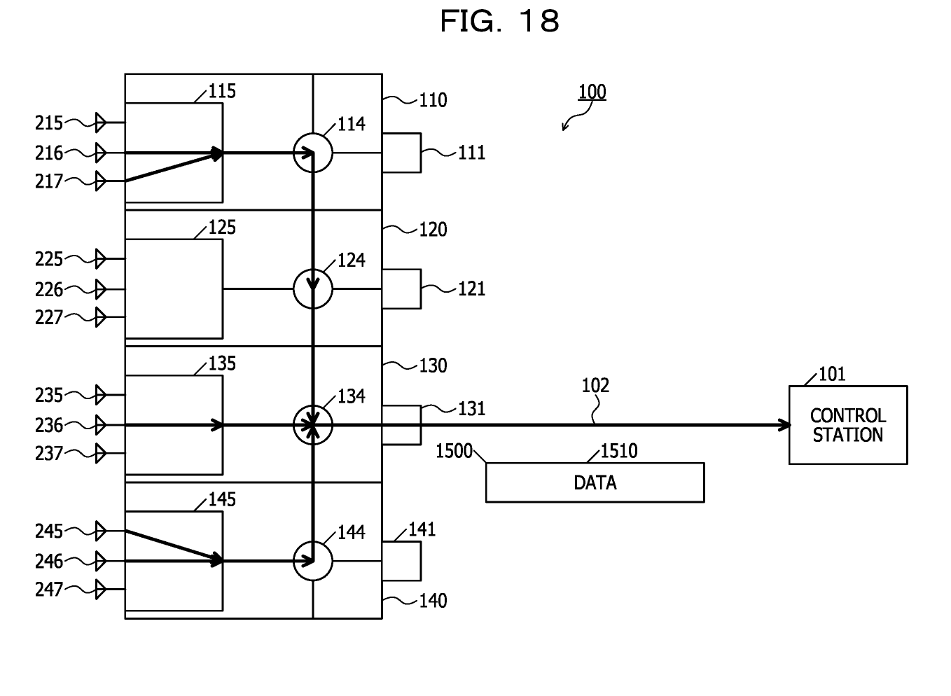

FIG. 18 is a diagram illustrating an example of a reception channel, for which a plurality of units and a plurality of antennas in the base station apparatus according to the embodiment are used. In FIG. 18, a portion that is the same as the portion that is illustrated in FIG. 17 is given the same reference numeral and a description thereof is omitted. In an example that is illustrated FIG. 18, in the reverse direction to that of the channel that is illustrated in FIG. 14, the base station apparatus 100 receives the UL data through the antennas 216, 217, 236, 245, and 246. That is, in the example that is illustrated in FIG. 18, reception that uses a plurality of antennas and acceptance of a stream from a plurality of units are performed.

The communication unit 115 of the antenna unit 110 weighting-composites pieces of data that are received by the antennas 216 and 217. Then, the communication unit 115 transfers the data that is obtained by the weighting combination, to the router 114. The communication unit 145 of the antenna unit 140 weighting-composites pieces of data that are received by the antennas 245 and 246. Then, the communication unit 145 transfers the data that is obtained by the weighting combination, to the router 144.

As illustrated in FIGS. 15 to 18, an antenna unit that has an antenna which is used for reception through the radio communication transmits the received signal, which is wirelessly received by an antenna of the antenna unit, to the control station 101 via a communication channel between each of the antenna units and the communication line 102. The control station 101 performs processing of the received signal that is transferred from the antenna unit that has the antenna which is used for the reception through the radio communication. The processing of the received signal by the control station 101, for example, includes transfer of the received signal to an apparatus that is at a higher level than antenna unit 110, or the like.

Accordingly, although the configuration is employed in which the control station 101 is coupled to only one or several of the antenna units 110, 120, 130, and 140, the control station 101 can perform the radio reception that uses a plurality of antennas of the antenna units 110, 120, 130, and 140.

Example of Processing by the Antenna Unit

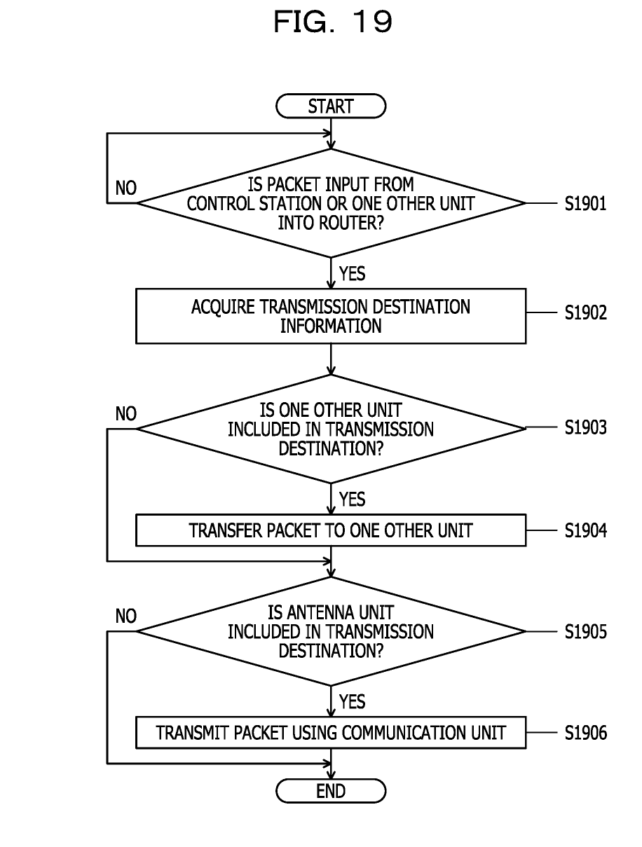

FIG. 19 is a flowchart illustrating an example of processing relating to the downlink signal that is received through the antenna unit according to the embodiment. The antenna unit 110, for example, performs each step that is illustrated in FIG. 19, as the processing relating to the downlink signal. The processing relating to the downlink signal that is received through the antenna unit 110 is described, but this is also true for the processing relating to the downlink signal that is received through each of the antenna units 120, 130, and 140.

First, the antenna unit 110 determines whether or not a packet is input from the control station 101 or one other unit into the router 114 (Step S1901) and waits unit the packet is input into the router 114 (a continuous No loop in Step S1901). For example, in a case where the control station 101 is coupled to the inter-control station I/F 111 of the antenna unit 110, a packet from the control station 101 is input into the router 114 through the inter-control station I/F 111. Furthermore, in a case where other units are coupled to the inter-unit I/Fs 112 and 113, packets from the units are input into the router 114 through the inter-unit I/Fs 112 and 113.

When, in Step S1901, a packet is input into the router 114 (Yes in Step S1901), the antenna unit 110 acquires transmission destination information indicating a transmission destination of the packet that is input (Step S1902). The transmission destination information of the packet, for example, is an address 1111 in the header 1110.

Next, the antenna unit 110 determines whether or not one other unit is included in the transmission destination that is indicated by the transmission destination information which is acquired in Step S1902 (Step S1903). In a case where the one other unit is not included in the transmission destination (No in Step S1903), the antenna unit 110 proceeds to Step S1905. In a case where the one other unit is included in the transmission destination (Yes in Step S1903), the antenna unit 110 transfers a packet that is input into the router 114, to the one other unit, based on the acquired transmission destination and the routing table 300 (refer to FIG. 3) (Step S1904).

Next, the antenna unit 110 determines whether or not the antenna unit is included in the transmission destination that is indicated by the transmission destination information which is acquired in Step S1902 (Step S1905). In a case where the antenna unit is not included in the transmission destination (No in Step S1905), the antenna unit 110 ends the sequence of processing steps. In a case where the antenna unit is included in the transmission destination (Yes in Step S1905), the antenna unit 110 transmits the packet that is input into the router 114, using the communication unit 115 (Step S1906), and ends the sequence of processing steps.

Steps S1901 to S1905, for example, are performed by the router 114 or a control circuit that controls the router 114 or the router 114. For example, the router 114 or the control circuit that controls the router 114 performs Step S1906 by transferring a packet from the router 114 to the communication unit 115. It is noted that the order in which the processing operations in Step S1903 and S1904 and the processing operations in Step S1905 and S1906 are performed may be reversed and that the processing operations in Step S1903 and S1904 and the processing operations in Step S1905 and S1906 may be simultaneously performed as parallel processing.

Example of the Processing by the Antenna Unit

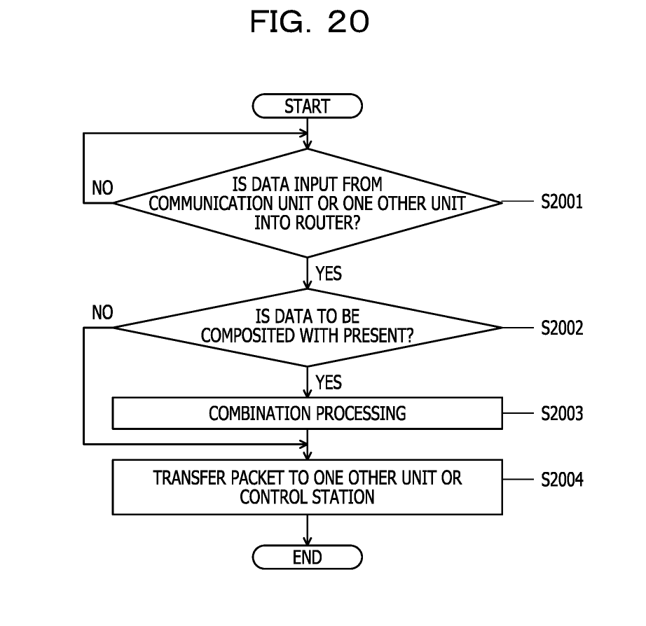

FIG. 20 is a flowchart illustrating an example of processing relating to the uplink signal that is received through the antenna unit according to the embodiment. The antenna unit 110, for example, performs each step that is illustrated in FIG. 20, as the processing relating to the uplink signal. The processing relating to the uplink signal that is received through the antenna unit 110 is described, but this is also true for the processing relating to the uplink signal that is received through each of the antenna units 120, 130, and 140.

First, the antenna unit 110 determines whether or not data is input from the communication unit 115 or one other unit into the router 114 (Step S2001) and waits unit the data is input into the router 114 (a continuous No loop in Step S2001). For example, when the data is wirelessly received by an antenna of the antenna unit 110, the received data is input from the communication unit 115 into the router 114. Furthermore, when the UL data (packet) is transferred from one other unit to the antenna unit 110, the transferred data is input from the inter-unit I/Fs 112 and 113 into the router 114.

When, in Step S2001, the data is input into the router 114 (Yes in Step S2001), the antenna unit 110 determines whether or not data that is to be composited with the data that is input into the router 114 is present (Step S2002). The data with which the data that is input into the router 114 is composited is data that has the same streaming ID as the data that is input into the router 114, and is data that is input into the same router 114 as the data that is input into the router 114. Whether or not the data to be composited with is present, for example, can be determined depending on whether or not a unit number of the antenna unit is included in combination unit numbers that are included in the packets that are transferred from other units.

In a case where, in Step S2002, the data to be composited with is not present (No in Step S2002), the antenna unit 110 proceeds to Step S2004. In a case where the data to be composited with is present (Yes in Step S2002), the antenna unit 110 performs processing that composites the data that is input into the router 114 and the data to be composited with (Step S2003).

Next, the antenna unit 110 transfers the packet that is input into the router 114 to one other unit or the control station 101 according to the routing table (Step S2004), and ends the sequence of processing steps. In a case where Step S2003 is performed, the packet that is transferred in Step S2004 is a packet that is obtained by the combination processing in Step S2003. Steps S2001 to S2004, for example, are performed by the router 114 or the control circuit that controls the router 114.

It is noted that the processing which determines whether or not to perform combination of pieces of data in each of the antenna units 110, 120, 130, and 140, but that no limitation to this processing is imposed. For example, a router of each of the antenna units 110, 120, 130, and 140, for example, may perform the combination processing at all times on pieces of UL data that are input around the same time. Furthermore, a router of each of the antenna units 110, 120, 130, and 140, for example, may be set to perform the combination processing that composites only data that is transmitted by the same polarized wave, among pieces of UL data that are input around the same time.

Example of the Transmitted Signal of the Base Station Apparatus

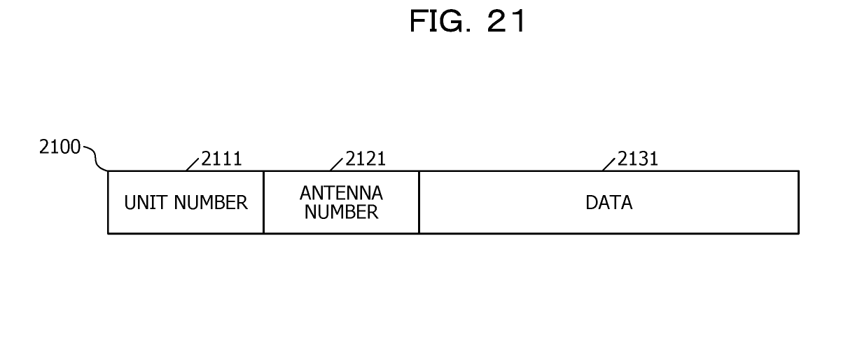

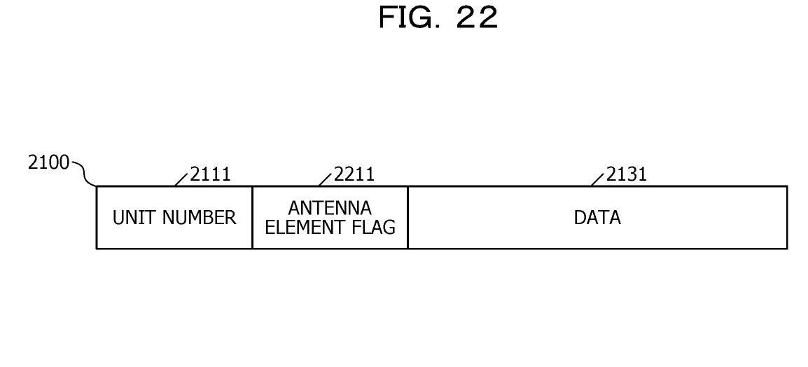

FIGS. 21 and 22 are diagrams, each illustrating an example of the transmitted signal in a case where the base station apparatus (can also be referred to as a base station system) according to the embodiment uses a single unit and a single antenna. For example, as illustrated in FIG. 11, in a case where the base station apparatus 100 performs transmission that uses delivery of a stream to a signal unit and a single antenna, a packet (for example, the transmitted signal 1100) that is transmitted by the control station 101, for example, can be set to be a transmitted signal 2100 that is illustrated in FIG. 21.

The transmitted signal 2100 that is illustrated in FIG. 21 includes a unit number 2111, an antenna number 2121, and data 2131. The unit number 2111 is an identification number of a single antenna unit that is used for the transmission, among the antenna units 110, 120, 130, and 140. The antenna number 2121 is an identification number of a single antenna that is used for the transmission, among antennas of the antenna unit that is indicated by the unit number 2111.

The unit number 2111 and the antenna number 2121, for example, correspond to the header 1110 that is illustrated in FIG. 11. The data 2131 is user data (for example, the data 1120 that is illustrated in FIG. 11) that is transmitted in DL.

Furthermore, like the transmitted signal 2100 that is illustrated in FIG. 22, the packet that is transmitted by the control station 101, for example, may be set to include an antenna element flag 2211 instead of the antenna number 2121 that is illustrated in FIG. 21. The antenna element flag 2211, for example, is information indicating whether or not to use each antenna of the antenna unit that is indicated by the unit number 2111.

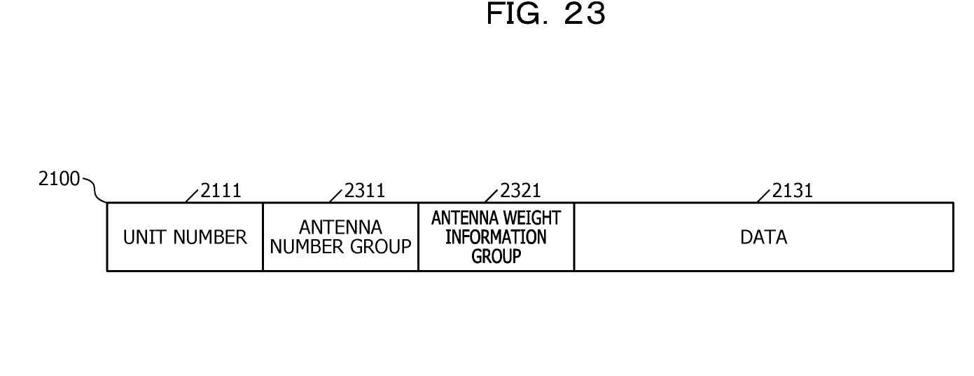

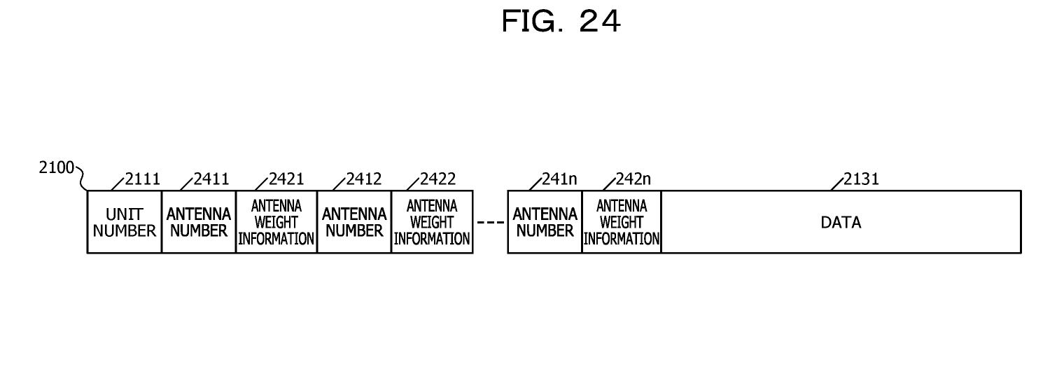

FIGS. 23 and 24 are diagrams, each illustrating an example of the transmitted signal in a case where the base station apparatus according to the embodiment uses a single unit and a plurality of antennas. In FIGS. 23 and 24, a portion that is the same as the portions that are illustrated in FIGS. 21 and 22 is given the same reference numeral and a description thereof is omitted. For example, as illustrated in FIG. 12, in a case where the base station apparatus 100 performs transmission that uses delivery of a stream to a signal unit and a plurality of antennas, the packet that is transmitted by the control station 101, for example, can be set to be the transmitted signal 2100 that is illustrated in FIG. 23.

The transmitted signal 2100 that is illustrated in FIG. 23 includes an antenna number group 2311 instead of the antenna number 2121 that is illustrated in FIG. 21, and an antenna weight information group 2321. The antenna number group 2311 is an identification number of each of the plurality of antennas that are used for the transmission, among antennas of the antenna unit that is indicated by the unit number 2111. The antenna weight information group 2321 indicates a weighting coefficient that applies to each antenna which is indicated by the antenna number group 2311.

Furthermore, the packet that is transmitted by the control station 101, for example, may be set to be the transmitted signal 2100 that is illustrated in FIG. 24. The transmitted signal 2100 that is illustrated in FIG. 24 includes antenna numbers 2411, 2412, and so forth up to 241n and pieces of antenna weight information 2421, 2422, and so forth up to 242n, instead of the antenna number group 2311 and the antenna weight information group 2321 that are illustrated in FIG. 23. The antenna numbers 2411, 2412, and so forth up to 241n are identification numbers of n antennas that are used for the transmission, among antennas of the antenna unit that is indicated by the unit number 2111. The pieces of antenna weight information 2421, 2422, and so forth up to 242n indicate n weighting coefficients, respectively, which apply to antennas that are indicated by antenna numbers 2411, 2412, and so forth 241n, respectively.

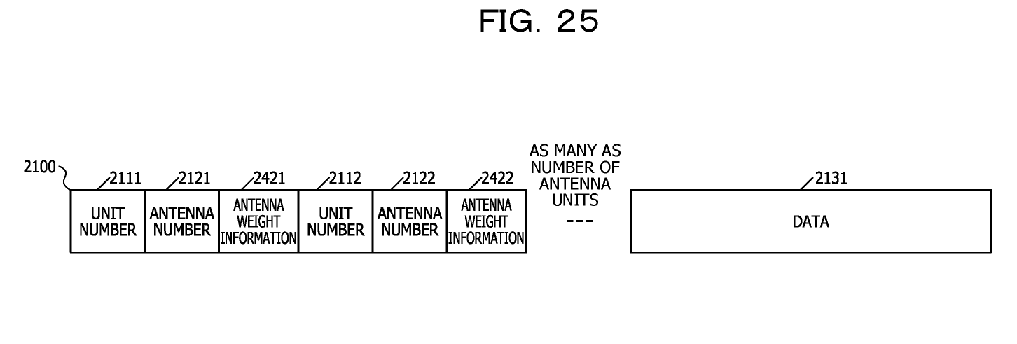

FIG. 25 is a diagram illustrating an example of the transmitted signal in a case where the base station apparatus according to the embodiment uses a plurality of units and a single antenna. In FIG. 25, a portion that is the same as the portions that are illustrated in FIGS. 21 to 24 is given the same reference numeral and a description thereof is omitted. For example, as illustrated in FIG. 13, in a case where the base station apparatus 100 performs transmission that uses delivery of a stream to a plurality of units and a single antenna, the packet that is transmitted by the control station 101, for example, can be set to be the transmitted signal 2100 that is illustrated in FIG. 25.

The transmitted signal 2100 that is illustrated in FIG. 25 includes unit numbers 2111, 2112, and so forth, antenna numbers 2121, 2122, and so forth, pieces of antenna weight information 2421, 2422, and so forth, and data 2131. The unit numbers 2111, 2112, and so forth are identification numbers of a plurality of antenna units that are used for the transmission, among the antenna units 110, 120, 130, and 140. Each of the antenna numbers 2121, 2122, and so forth is an identification number of a single antenna that is used for the transmission, among antennas of an antenna unit that is indicated by each of the unit numbers 2111, 2112, and so forth. The pieces of antenna weight information 2421, 2422, and so forth indicate weighting coefficients, respectively, which apply to antennas that are indicated by antenna numbers 2121, 2122, and so forth, respectively.

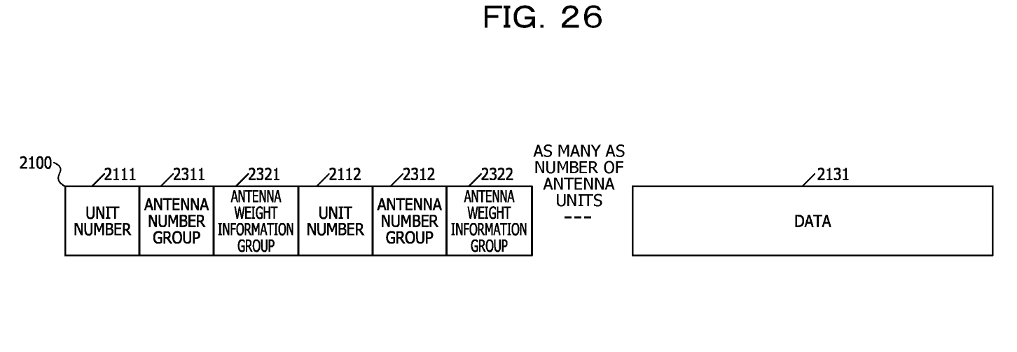

FIG. 26 is a diagram illustrating an example of the transmitted signal in a case where the base station apparatus according to the embodiment uses a plurality of units and a plurality of antennas. In FIG. 26, a portion that is the same as the portions that are illustrated in FIGS. 21 to 25 is given the same reference numeral and a description thereof is omitted. For example, as illustrated in FIG. 14, in a case where the base station apparatus 100 performs transmission that uses delivery of a stream to a plurality of units and a plurality of antennas, the packet that is transmitted by the control station 101, for example, can be set to be the transmitted signal 2100 that is illustrated in FIG. 26.

The transmitted signal 2100 that is illustrated in FIG. 26 includes the unit numbers 2111, 2112, and so forth, antenna number groups 2311, 2312, and so forth, pieces of antenna weight information group 2321, 2322, and so forth, and the data 2131. Each of the antenna numbers 2311, 2312, and so forth is an identification number of each of the plurality of antennas that are used for the transmission, among antennas of an antenna unit that is indicated by each of the unit numbers 2111, 2112, and so forth. The pieces of antenna weight information 2321, 2322, and so forth indicate weighting coefficients, respectively, which apply to antennas that are indicated by the antenna number groups 2311, 2312, and so forth, respectively.

The examples of the transmitted signal 2100, which is transmitted by the control station 101, are described with reference to FIGS. 21 to 26, but a format of the transmitted signal 2100 is not limited to these. For example, in addition to the information described above, the transmitted signal 2100 may include radio resource information. The radio resource information, for example, is information indicating a radio resource, such as a frequency or a time, to which the data 2131 is matched. The radio resource information, for example, is used in the communication unit of each of the antenna units 110, 120, 130, and 140.

Example of the Reception Signal of the Base Station Apparatus

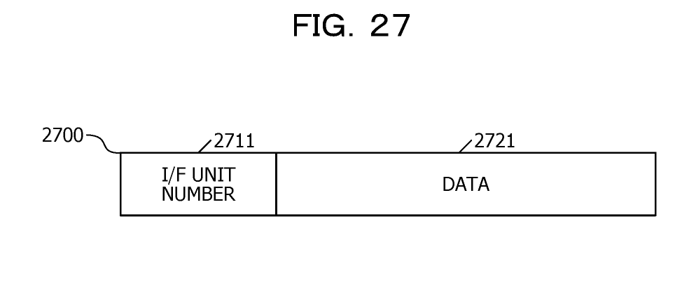

FIG. 27 is a diagram illustrating an example of the received signal in a case where the base station apparatus according to the embodiment uses a single unit. For example, as illustrated in FIG. 15, in a case where the base station apparatus 100 performs acceptance that uses a single antenna and acceptance of a stream from a single unit, a received signal that is transferred by each antenna unit, for example, can be set to be a received signal 2700 that is illustrated in FIG. 27. Furthermore, for example, as illustrated in FIG. 16, in a case where the base station apparatus 100 performs acceptance that uses a plurality of antennas and acceptance of a stream from a single unit, a received signal that is transferred by each antenna unit, for example, can be set to be a received signal 2700 that is illustrated in FIG. 27.

The received signal 2700 that is illustrated in FIG. 27 includes an I/F unit number 2711 and data 2721. The I/F unit number 2711 is an identification number of an antenna unit that is coupled (interfaced) to the control station 101, among the antenna units 110, 120, 130, and 140. The data 2721 is user data that is received by any of the antenna units 110, 120, 130, and 140.

The I/F unit number 2711, for example, is added to the data 2721 by a router of the antenna unit that wirelessly receives the data 2721, among the antenna units 110, 120, 130, and 140.

Based on the I/F unit number 2711 and the routing table, each of the antenna units 110, 120, 130, and 140 transfers the received signal 2700 to an antenna unit that is coupled to the control station 101, among the antenna units 110, 120, 130, and 140. Regarding the received signal 2700 to the antenna unit that is coupled to the control station 101 among the antenna units 110, 120, 130, and 140, the data 2721 that is included in the transferred received signal 2700 is transmitted, as the data 1510 described above, to the control station 101.

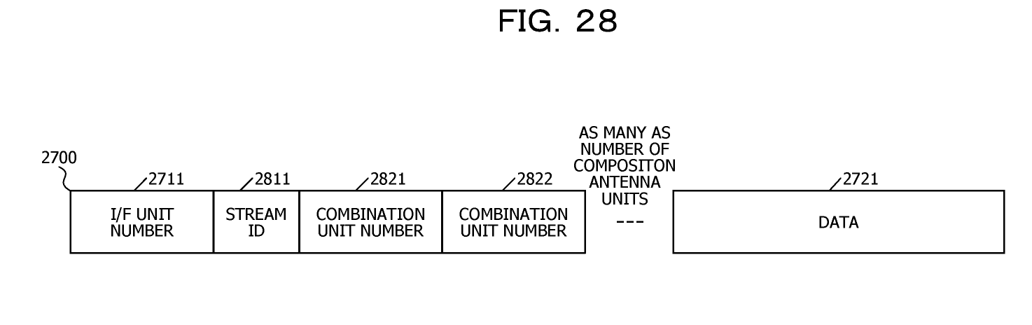

FIG. 28 is a diagram illustrating an example of the received signal in a case where the base station apparatus according to the embodiment uses a plurality of units. In FIG. 28, a portion that is the same as the portion that is illustrated in FIG. 27 is given the same reference numeral and a description thereof is omitted. For example, as illustrated in FIG. 17, in a case where the base station apparatus 100 performs reception that uses a single antenna and acceptance of a stream from a plurality of units, a received signal that is transferred by each antenna unit, for example, can be set to be the received signal 2700 that is illustrated in FIG. 28. Furthermore, for example, as illustrated in FIG. 18, in a case where the base station apparatus 100 performs reception that uses a plurality of antennas and acceptance of a stream from a plurality of units, a received signal that is transferred by each antenna unit, for example, can be set to be the received signal 2700 that is illustrated in FIG. 28.

The received signal 2700 that is illustrated in FIG. 28 includes the I/F unit number 2711, a stream ID 2811, and combination unit numbers 2821, 2822, and so forth, and the data 2721. The stream ID 2811 is an identification of a stream of the data 2721.

The combination unit numbers 2821, 2822, and so forth are identification numbers of antenna units that composite the data 2721, among the antenna units 110, 120, 130, and 140. The antenna unit that composites pieces of data 2721 is an antenna unit into which a plurality of received signals 2700 each of which includes the pieces of data 2721 which have the same stream ID 2811 are input.

In a case where a unit number of the antenna unit is included in the combination unit numbers 2821, 2822, and so forth, each of the antenna units 110, 120, 130, and 140 can determine that the antenna unit is an antenna unit which performs the combination processing. The antenna unit that performs the combination processing waits for the input of a plurality of received signals 2700 that have the same stream ID 2811, and composites the plurality of received signals 2700 that are input, for transfer. At this time, the antenna unit that performs the combination processing may delete the unit number of the antenna unit, of the combination unit numbers 2821, 2822, and so forth, and may transfer the received signal 2700 from which the unit number of the antenna unit is deleted.

Furthermore, instead of the I/F unit number 2711 that is illustrated in FIGS. 27 and 28, as described above, the address “1.1” of the control station 101 may be added, as the transmission destination address, to the received signal 2700. In this case, based on the address “1.1” of the control station 101 and the routing table, each of the antenna units 110, 120, 130, and 140 transfers the received signal 2700 to the control station 101.

Furthermore, the examples of the received signal 2700 that is transferred by each antenna unit is described with reference to FIGS. 27 and 28, but a format of the received signal 2700 is not limited to these. For example, in addition to the information described above, the received signal 2700 may include information indicating a user or the like.

Other Examples of the Coupling Between the Antenna Unit and the Control Station

FIG. 29 is a diagram illustrating another example of the coupling between the antenna unit and the control station according to the embodiment. In FIG. 29, a portion that is the same as the portion that is illustrated in FIG. 1 is given the same reference numeral and a description thereof is omitted. For example, a configuration in which the control station 101 and the inter-control station I/F 121 are coupled to each other with the communication line 102 is described referring to an example that is illustrated in FIG. 1, but the control station 101 may be coupled to a plurality of inter-control station I/Fs, among the inter-control station I/Fs 111, 121, 131, and 141. In an example that is illustrated in FIG. 29, the control station 101 is coupled to the inter-control station I/F 121 through the communication line 102, and is further coupled to the inter-control station I/F 131 through a communication line 2901.

In this case, the antenna unit 120 and the antenna unit 130 are master units that are coupled directly to the control station 101. In this manner, the number of communication lines between each of the antenna units 110, 120, 130, and 140 and the control station 101 can be increased according to throughput of data that is transferred in the base station apparatus 100. Furthermore, no limitation to the number of physical communication lines is imposed, and for example, the number of logical communication lines in the control station 101 may be increased.

Furthermore, a configuration in which the BB unit is provided in each of the antenna units 110, 120, 130, and 140 and precoding for beamforming is performed in the antenna units 110, 120, 130, and 140 is described, but no limitation to this configuration is imposed. For example, a configuration may be employed in which the baseband processing such as precoding by the antenna units 110, 120, 130, and 140 is performed in the control station 101 without the BB unit being provided in the antenna units 110, 120, 130, and 140.

Furthermore, a configuration in which the routing is performed with a combination of the unit number and the antenna number is described, but no limitation to this configuration is imposed. For example, a configuration in which a unique antenna number is added to all antennas of each of the antenna units 110, 120, 130, and 140 and the routing is performed only with the antenna number may be employed. That is, the transmission destination address described above may be an identification information that possibly specifies an antenna of a transmission destination.

In this manner, in the case of the base station apparatus according to the embodiment, a configuration in which only one or several antenna units among a plurality of antenna units are coupled to the control station via the communication line and the radio communication is performed via the communication line and the communication channel between each of the antenna units can be employed. Accordingly, the antenna configuration that has a high degree of freedom in the base station apparatus is possible.

For example, it is possible that an antenna unit that is not coupled to the control station among a plurality of antenna units is easily removed. Furthermore, a new antenna unit is coupled to an existing antenna unit, and thus the new antenna unit may not be coupled to the control station. Because of this, one or more antenna units can be additionally installed in an easy manner. For this reason, flexible setting for antenna configurations for the number of antennas, an arrangement of antennas, and the density of antennas is possible according to an environment where the base station apparatus is installed or a performance of the base station apparatus that is set according to a cell design. Furthermore, flexible change of the antenna configuration in accordance with a usage situation of the base station apparatus or the like is possible.

Furthermore, a communication line that couples an antenna apparatus which is realized by a plurality of antenna units and the control station may be coupled only to one or several antenna units among a plurality of antenna units. Because of this, wiring in the base station apparatus can be simplified.

Furthermore, a plurality of interfaces that are possibly coupled to other antenna units are provided in each of the antenna units, and thus various antenna configuration can be realized with a combination of a plurality of antenna units. Because of this, the versatility of the antenna unit can be increased. For this reason, a reduction in the cost of manufacturing the base station apparatus or in the design cost can be accomplished.

In this case, a plurality of antenna units can form a communication channel using an interface that is coupled to one other antenna unit among a plurality of interfaces and a router. Furthermore, the inter-control station I/F that possibly communicates with the control station is provided in each of the plurality of antenna units, and thus it is possible that the control station is also coupled to any antenna unit of the plurality of antenna units. However, a configuration may be employed in which the inter-control station I/F is provided only in the antenna unit that is coupled to at least the control station without the inter-control station I/F being provided in all of the plurality of antenna units.

As described above, with the base station apparatus and the communication control method, the antenna configuration that has a high degree of freedom can be realized. The antenna configuration that has a high degree of freedom is realized, and thus, for example, a cell configuration that has a high degree of freedom is possible.

For example, in recent years, research and development of a 5th generation mobile communication system has been conducted. In the 5th generation mobile communication system, as a result of an increase in data transfer speed, an amount of data along the communication line that provides a link between the control station and an overhanging RRH is increased. On the other hand, an antenna that is configured with many antenna elements, which is called a massive antenna, has been studied, but technology development toward practical application, which employs an antenna configuration different from that in the related art, is demanded.

For example, in the massive antenna, various antenna configurations for the number of antennas, the arrangement of antennas and the density of antennas can be employed, but for example, an antenna configuration that has a high degree of freedom can be realized in the related art in which coupling to each of the RRH (the antenna unit) and the BBU (the control station) is made.

In contrast, according to the embodiment described above, the configuration can be employed in which a plurality of antennas units are coupled to each other, in which only one or several antenna units of the plurality of antenna units is coupled to the control station via the communication line, and in which the control station performs the radio communication via the communication line and the communication channel between each of the antenna apparatuses. Accordingly, the antenna configuration that has a high degree of freedom is possible.

For example, the transmission and reception of the radio signal according to any antenna configuration, or MIMO multiplexing and beamforming or the like according to any antenna configuration can be realized at low cost. Furthermore, the number of logical or physical communication lines between the antenna unit and the control station can be changed according an amount of information that is transferred by a plurality of antenna units.

All examples and conditional language recited herein of the RFID tag and the high frequency circuit are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station system comprising:
a plurality of antenna units each of which includes an antenna and is configured to be coupled to the plurality of antenna units via a communication channel; and
a control circuit configured to be connected to at least one of the plurality of antenna units via a communication line, the control circuit being configured to perform radio communication using any of the plurality of antenna units via the connected antenna unit.

2. The base station system according to claim 1,
wherein each of the plurality of antenna units includes a plurality of first interfaces and a router coupled to the plurality of first interfaces, each of the plurality of first interfaces being configured to be coupled to other antenna units among the plurality of antenna units, and
wherein the communication channel is formed by each of the plurality of antenna units performing routing using a first interface that is coupled to other antenna units among the plurality of first interfaces, and the router.

3. The base station system according to claim 2,
wherein the connected antenna unit includes a second interface different from the plurality of first interfaces, the second interface being configured to be coupled to the control circuit via the communication line, and
wherein the router is further configured to be coupled to the second interface.

4. The base station system according to claim 3,
wherein the control circuit is configured to transmit a transmitted signal that includes data which is transmitted through the radio communication, to an antenna unit that has an antenna which is used for the transmission through the radio communication among the plurality of antenna units, via the communication line and the communication channel, and
wherein the antenna unit that has the antenna which is used for the transmission through the radio communication is configured to wirelessly transmit the data that is included in the transmitted signal, which is transmitted from the control circuit, from the antenna.

5. The base station system according to claim 4,
wherein the control circuit is configured to transmit the transmitted signal that includes the data and identification information which possibly specifies an antenna that is used for the transmission through the radio communication, and
wherein the plurality of antenna units are configured to transfer the transmitted signal to the antenna unit that has the antenna which is used for the transmission through the radio communication, by the routing that is based on the identification information.

6. The base station system according to claim 5,
wherein the radio communication is radio communication that simultaneously uses a plurality of antennas among the antennas of the plurality of antenna units, and
wherein the control circuit is configured to transmit the transmitted signal that includes identification information which possibly specifies the plurality of antennas.

7. The base station system according to claim 1,
wherein each of the plurality of antenna units is configured to transmit a received signal, which is wirelessly received by the antenna, to the control circuit via the communication channel and the communication line when the antenna included in the each of the plurality of antenna units is associated with the control circuit.

8. The base station system according to claim 7,
wherein the radio communication is for radio reception by using simultaneously a plurality of antennas associated with the control circuit,
wherein the connected antenna unit is configured to perform transfer processing when a plurality of received signals are provided, via the plurality of first interfaces, from the plurality of antennas associated with the control circuit, and
wherein the transfer processing includes compositing the plurality of received signals and transferring a signal that results from the combination to the control circuit.

9. The base station system according to claim 1,
wherein the plurality of antenna units include an antenna unit that has a plurality of the antennas.

10. The base station system according to claim 9,
wherein the antenna unit that has the plurality of the antennas has a baseband processing unit that controls the radio communication by each antenna of the antenna unit.

11. The base station system according to claim 1,
wherein the control circuit is configured to control the radio communication that uses a plurality of antennas among the antennas of the plurality of antenna units.

12. A communication control method that is performed by a base station system, the method comprising:
performing routing processing that forms a communication channel via which mutual communication is possible, by a plurality of antenna units in the base station system, each of the plurality of antenna units including at least an antenna and being configured to be coupled to the plurality of antenna units via the communication channel; and
receiving a plurality of received signals from a plurality of antennas associated with the control circuit, by a control circuit configured to be connected to at least one of the plurality of antenna units, the plurality of antennas being included in any one or more of the plurality of antenna units, via a communication line and via the communication line and the communication channel.
